(19) United States
(12) Patent Application Publication
(10) Pub. No.: US 2026/0267122 A1
(43) Pub. Date: Sep. 10, 2026

(54) METHOD, MINFLUX MICROSCOPE AND COMPUTER PROGRAM FOR LOCALIZING OR TRACKING EMITTERS

(71) Applicant: ABBERIOR INSTRUMENTS GMBH, Gottingen (DE)

(72) Inventors: Matthias REUSS, Gottingen (DE); Roman SCHMIDT, Gottingen (DE); Winfried WILLEMER, Bovenden (DE); Gerald DONNERT, Gottingen (DE)

(21) Appl. No.: 19/165,964

(22) PCT Filed: Mar. 15, 2024
(86) PCT No.: PCT/EP2024/056943

§ 371 Date: Sep. 16, 2025

(30) Foreign Application Priority Data
Mar. 22, 2023 (EP) 23163585.5

(51) Int. Cl. G02B 21/00; G01N 21/64

(52) U.S. Cl. CPC G02B 21/0076; G01N 21/6458; G02B 21/0032; G02B 21/0048; G01N 2201/11

(57) ABSTRACT

A method and a MINFLUX microscope (1) for localizing or tracking an emitter, wherein a sample is illuminated in a close range of the emitter by an illumination light beam with an intensity distribution of illumination light that comprises a central minimum, wherein the intensity distribution is displaced to scanning positions during a measurement cycle by a beam scanner (6) with at least one optical component (61, 62, 63, 64) and wherein emissions from the emitter are detected for the scanning positions and assigned to the scanning positions, wherein the beam scanner (6) is controlled by control signals, and the control signals and/or nominal movements of the at least one optical component (61, 62, 63, 64) can be described as a function of time by a sine function or by a weighted sum of sine functions with a finite number of summands.

### TECHNICAL FIELD

The present disclosure relates to methods for localizing or tracking emitters in a sample using an illumination light focused into an intensity distribution with a central minimum, as well as a MINFLUX microscope and a computer program for carrying out the method.

### PRIOR ART

A method for determining the position of an emitter in a sample and for tracking an emitter in a sample using a focused illumination light whose focus is displaced along a path around an emitter is known in the prior art and is now referred to as the “orbital method” or, depending on the application, as “orbital tracking” or “orbital scanning.”

Such a method is proposed in the publication “Tracking of fluorescent molecules diffusing within membranes” (Jörg Enderlein, Appl. Phys. B 71, 773-777 (2000); DOI: 10.1007/s003400000409) and further explained in the publication “Positional and Temporal Accuracy of Single Molecule Tracking” (Jörg Enderlein, Single Mol., 1: 225-230. https://doi.org/10.1002/1438-5171). In this method, a Gaussian laser beam is focused into the plane of motion of the molecule to be observed. The laser focus is moved along a circular path with a fixed radius. According to the second publication, the same applies to the focus point of the confocal detection. After each revolution, the center of the circle is adjusted to a new position according to the photon detection intensities observed along the circular path, wherein the direction of the adjustment is determined optimally and the radial displacement is determined by simple approximation. The latter publication discusses the achievable accuracy of determining the position of a stationary fluorophore, i.e., its localization. The method is reported as implementable using commercially available piezo scanners and piezo tables.

The publication “Scanning FCS, a novel method for three-dimensional particle tracking” (Levi V. et al., Biochem Soc Trans. 2003 October; 31(Pt 5):997-1000. doi: 10.1042/bst0310997. PMID: 14505467) describes a method based on the principle of orbital tracking without referring to either of the two publications mentioned above. A Gaussian laser beam is used fortwo-photon excitation of fluorescence. It is guided alternately along two circular paths, each around a center on an optical axis, with one center above and the other below the particle to be tracked. The focus is displaced along the circular path using a galvo scanner. The axial position of the particle is determined from the difference between the fluorescence signals averaged over several revolutions. The lateral position of the particle is determined by calculating a mean discrete signal profile from several revolutions, depending on the signal level, around a center (recorded at 32 kHz at a rotation frequency of 250 Hz, i.e., 128 data points), which is analyzed using a fast Fourier transform (FFT). The phase of the fundamental frequency, the “AC term,” determined from this is reported to correspond directly to the angular coordinate of the position of the observed particle, while the ratio of the “DC” component, to the “AC term,” i.e., the modulation “AC/DC,” is reported to be usable to determine the radial distance of the particle's position from the orbit axis; this distance is reported to be a monotonic function of the modulation, which depends on the half-width of the point spread function and the radius of the orbit. The latter relationship is not explained in more detail.

The dissertation “Trapping and Manipulating Single Molecules in Solution” (Adam E. Cohen, dissertation, Stanford University, defended August 2006) describes how a fluorescent particle is tracked using a focus that orbits close to the particle, similar to orbital scanning, with the focus being deflected by acousto-optic deflectors. In one embodiment, where the detection rate of the fluorescence photons is lower than the orbit frequency of the focus, a piezo displacement unit is moved in such a way that the focus is moved radially outward in the focal plane whenever a photon is detected during the orbit, thereby shifting the orbit relative to the particle in such a way that the particle is kept in the center of the orbit. At detection rates greater than the rotation frequency, the displacement unit moves after each full rotation in accordance with the photons detected during a rotation.

In the publication “Real-time nanomicroscopy via three-dimensional single-particle tracking” (Katayama Y. et al., Chemphyschem. 2009 Oct. 5; 10(14):2458-64. doi:10.1002/cphc.200900436. PMID: 19760694; PMCID: PMC2857558.) the term “orbital tracking” is finally used. It describes an orbital tracking in which an excitation focus is moved along a circular path within a plane while the emission is detected in two planes that are slightly offset axially in opposite directions relative to the confocal plane. It also describes that orbital tracking is performed while simultaneously capturing a wide-field image of the sample using a different excitation wavelength. Orbital tracking is performed using a piezo scanner.

The publication “Nanoresolution real-time 3D orbital tracking for studying mitochondrial trafficking in vertebrate axons in vivo” (Wehnekamp, F. et al., (2019), eLife 8:e46059, https://doi.org/10.7554/eLife.46059) also describes a combination of orbital tracking and wide-field imaging. Orbital tracking is performed using a photoactivatable fluorescent dye, which enables the tracking of individual organelles in a densely stained background.

The orbital method is usually described in connection with the use of a beam scanning device based in particular on galvo scanners. When using galvo scanners, a circular path is traversed by controlling an x and a y deflection unit at the same frequency, with the deflection curve following a sine function over time. The radius of the path scales with the amplitude of the deflection, and the center of the circular path corresponds to the mean value of the deflection.

The publication “Optimal laser scan path for localizing a fluorescent particle in two or three dimensions” (Gregg M. Gallatin and Andrew J. Berglund, Opt. Express 20, 16381-16393 (2012)) deals with the theoretical determination of scan paths that are optimal in terms of the accuracy with which an emitter can be localized by scanning with a focused beam. One result of the analysis is that for any standard scalar figure of merit that can be defined using the Fisher information matrix, the optimal path is to keep the particle at the positions of maximum slope of the square root of the intensity rather than at the position of maximum intensity itself. In one dimension, this is reported to be equivalent to maximizing the signal-to-noise ratio. Localization accuracy is reported to be optimizable by maximizing this gradient. The analysis is limited to the consideration of particles that move only slightly in relation to the scanned area during the respective scanning period. The analysis initially assumes a position-dependent intensity distribution that can be displaced. Specific results are determined for Gaussian intensity distributions. For these, the optimal path is reported to be a circular path with a radius corresponding to the beam width divided by the square root of 2 (two).

In the prior art relating to microscopy, various scanning methods are known for scanning a sample with a light spot, which differ, among other things, in terms of the scanning patterns. Scanning is performed by displacing a light spot relative to a sample, which can also be achieved by moving the sample. For example, raster scanning methods are widely used in confocal microscopy and STED microscopy. The term raster scan is now used for many types of scanning on a fixed pattern. Originally, this term was used for methods in which scanning is performed along lines, each of which is advanced, similar to the image generation of television tubes. In addition to line-by-line scanning, there are also scanning methods in which scanning is performed along a Lissajous curve, a cycloid, a spiral path, or several spiral paths placed next to each other.

For example, international patent publication WO 2004/079405 A2 proposes scanning methods, e.g., for confocal microscopy, which are intended to enable faster image acquisition using mechanical beam deflection devices. High accelerations of the mechanical beam deflection devices lead to stresses. To minimize these stresses when using the beam deflection device, the accelerations occurring during scanning should be minimized. To this end, control of the deflection device with sinusoidal waveforms is optimal. Various control signals and corresponding scan paths of a light beam are proposed. The control signals for an x-direction and a y-direction are sinusoidal and cosine signals, respectively, which vary slowly overtime and, at most, vary rapidly at a single specific point in time during the traversal of an entire path. The resulting scan paths are various spiral paths or combinations of spiral paths.

The older Japanese patent disclosures JP 2000-098238 A and JP 2005-241321 A also describe scanning methods in which image fields are scanned along spiral paths. The spiral paths are generated by controlling individual scanners with signals that correspond exactly or essentially to a product of a time-dependent sine or cosine function at a first frequency and a further sine or cosine function at a second frequency. In JP 2005-241321 A, such a control signal is modified in such a way that frequencies change depending on time, so that the tangential velocity of the scanning movement remains constant during scanning. The scanning methods according to the two documents were marketed by Olympus under the name Tornado Scanning as a scanning method exclusively for illumination, for example, for FLIP, FRAP, photo activation, or photo conversion, uncaging, etc. The disclosure JP 2000-098238 A mentions that the individual deflection units of the scanner could also be controlled with a pure sine or cosine signal in such a way that the scanning path corresponds to a Lissajous figure.

German patent specification DE 10 2016 117 096 B4 describes imaging methods, in particular using STED microscopy, in which a particularly high resolution is achieved by scanning only a close range of the object to be imaged with an intensity profile, for example of the STED light, with a central minimum, so that the object to be imaged is not exposed to the high intensities of the maxima limiting the minimum at any time during scanning and is therefore not bleached during scanning. Scanning with the intensity distribution can be performed on a rectangular grid, or scanning can be performed on a spiral path starting from the center of the object to be imaged.

The term “MINFLUX microscopy” or “MINFLUX method” refers to localization and tracking methods for individual emitters in which light distributions of illumination light that excites light emissions from the emitter are generated at the focus in the sample, wherein the light distributions comprise a local minimum and in which the position of an individual emitter is determined by detecting light emissions from the emitter for different positions of the minima of the relevant light distributions or for different such light distributions in a close range of the emitter, wherein particular advantage is taken of the fact that the smaller the distance between the emitter and the minimum of the light distribution, the less light is emitted by the emitter. At the minimum itself, the emitter should be stimulated to emit as little as possible, so that the increase in emission with increasing distance from the minimum of the light distribution is as large as possible in relation to the emission in each case. Due to the latter fact, MINFLUX methods are particularly photon-efficient, especially in comparison to localization methods based on spatially resolved detection of the emission, such as those known from PALM or STORM microscopy. This means that with the same number of detected photons, MINFLUX methods achieve a particularly high degree of localization accuracy. This makes it possible to illuminate the emitters to be localized or tracked with the desired accuracy with relatively little light compared to other localization methods, and therefore they are less likely to be bleached.

A method of the type described above is described in patent application DE 10 2011 055 367 A1 for single-molecule tracking. According to the method disclosed therein, the position of a single fluorophore is tracked over time by tracking an excitation light distribution with a local minimum to the fluorophore in such a way that the fluorescence emission rate is minimal.

The patent DE 10 2013 114 860 B3 describes in particular a localization method in which the sample is scanned at grid points with the local minimum of an excitation light distribution to localize single fluorophores.

The term “MINFLUX” is introduced in the publication “Nanometer resolution imaging and tracking of fluorescent molecules with minimal photon fluxes” (Balzarotti F. et al., Science. Feb. 10, 2017; 355(6325):606-612 and in advance arXiv:1611.03401 [physics.optics](2016)). The method described there implements the MINFLUX principle in concrete terms by identifying small structures (DNA origamis) comprising stochastically blinking fluorophores in a wide-field image and moving them as precisely as possible to the center of the wide-field image, and then scanning the center area with a donut-shaped excitation light distribution in the center and at further points that form a symmetrical pattern of illumination positions around the center using an electro-optical scanner; the positions of the individually blinking fluorophores of the structures are then determined with an accuracy of a few nanometers using a maximum likelihood estimator from the photon counts recorded for the individual illumination positions. With the same number of detected photons, the smaller the area bounded by the scanning positions in which the fluorophore to be localized is located, the higher the accuracy. It is therefore advantageous to perform MINFLUX iteratively on individual fluorophores, reducing the bounded area step by step.

International patent publication WO 2022/029283 A1 describes a further MINFLUX method. This method uses an illumination pattern with six or more illumination positions that are rotationally symmetrical on a circle around a previously estimated position of an emitter. The illumination positions can be addressed step by step or in a continuous motion, in which case a section of the circular path can be treated collectively as a discrete scanning point. In one embodiment of this method, background fluorescence is determined and taken into account when determining the position of the fluorophore from the measured values obtained at the positions of the illumination pattern.

European patent EP 3 372 990 B1 describes, among other MINFLUX methods, a method that is similar to the MINFLUX method in one aspect. As in a MINFLUX method, an individual molecule is focused and subjected to an intensity distribution that comprises a central minimum, particularly a zero point, and surrounding increase areas; also as with MINFLUX, this minimum is placed at a plurality of scanning points around the presumed location of the individual molecule and a fluorescence emission is detected for each scanning point; the actual position is estimated with high accuracy from the intensity values or photon counts obtained in this way. In contrast to MINFLUX, the intensity distribution is a distribution of fluorescence-inhibition light, in particular STED light. It is applied together with excitation light, wherein the intensity distribution of the excitation light does not have a central local minimum. While with MINFLUX the fluorescence emission is higher when the individual molecules are further away from the central minimum of the intensity distribution, with this method the opposite is true.

The publication “A common framework for single-molecule localization using sequential structured illumination” (Luciano A. Masullo et al.; Biophysical Reports, Volume 2, Issue 1, 2022, 100036; https://doi.org/10.1016/j.bpr.2021.100036), it is shown that various methods for single-molecule localization can be understood as belonging to a common concept. Among other things, the publication describes the method described in the above-mentioned disclosure WO 2022/029283 A1, which uses an excitation light distribution with a central minimum with illumination positions that are rotationally symmetrical on a circle around a previously estimated position, as a new method and refers to it as “Orbital Tracking with a MINimum” (OTMIN). Furthermore, a method for localization from a raster scan limited to a small area around the fluorophore to be localized, using an intensity minimum for scanning, as already described in essence in patent DE 10 2013 114 860 B3, is presented and referred to as “RASTer scanning with a MINimum” (RASTMIN). These two methods are then combined with, among other things, (classical) orbital tracking, localization from a confocal scan limited to a small area around the fluorophore to be localized, and MINFLUX according to the version described in “Nanometer resolution imaging and tracking of fluorescent molecules with minimal photon fluxes” (Balzarotti, see above) with four scanning points, one of which corresponds to a central position, are then subsumed under the term “single-molecule localization by sequential structured illumination” (SML-SSI). The achievable accuracies of localization are investigated. With reference to OTMIN, it is found that particles near the center could be localized very accurately, while particles near the circle with the scanning positions could be determined with significantly less accuracy. In this context, it is mentioned that the high uncertainty could be avoided experimentally by feeding information into the measurement to use a field of view that is limited to the well-preserved inner area, e.g., by periodically tracking the pattern in real time.

### Objective

It is an objective of the present disclosure to improve scanning methods for determining the position of an emitter in a sample and for tracking an emitter in a sample using an illumination light, wherein the intensity distribution of the illumination light comprises a local intensity minimum and wherein the intensity distribution is displaced around an emitter, such that high speed and high accuracy are achieved with technically simpler means.

### Solution

The objective is attained by the subject matter of the independent claims. Advantageous embodiments of the invention are specified in the subclaims and are described below.

### Definitions

In this application, emitters are understood to be objects which, when illuminated with excitation light, can be regarded as point light sources with regard to the measurements according to the present disclosure. The light emitted by the object acting as a point light source may, for example, be scattered light resulting from elastic scattering such as Rayleigh scattering or inelastic scattering such as Raman scattering, or it may be luminescent light, in particular fluorescent light. It is essential for an emitter that light is emitted from it immediately or with a small time delay in response to illumination. In this case, the maximum time delay when movements of the emitter are to be tracked is related to the temporal resolution with which the movements of the light-emitting particles or light-emitting units are to be tracked and to the speed at which the particles or units move in the sample. The time delays may be up to about 10 ρs, but are usually in the range of up to several tens of nanoseconds, often in the range of 1 to 10 ns, and, if the emission is scattered light, zero. In this application, the term “fluorescence emitter” is used to refer to emitters that act as point sources of fluorescence. Emitters may be metallic nanoparticles, for example. The more specific term “fluorescence emitter” includes, for example, individual fluorescent dye molecules or their fluorescent chemical groups. Instead of dyes, other fluorescent units such as quantum dots or upconverting nanoparticles may also be used for labeling. In the context of the application, excitation light is therefore understood not only as fluorescence excitation light, but generally as light that causes light to be emitted from an emitter.

In the context of the application, an emitter is referred to as individual if the distance to the nearest neighboring emitter, from which it is optically indistinguishable, is at least as large as the distance corresponding to the resolution of the optical arrangement used to detect the emissions when the method is carried out.

In this application, STED light is understood, as is generally customary, to mean light that suppresses fluorescence emission through stimulated emission depletion. STED light is a special form of emission inhibition light within the scope of this application.

In this application, the term “MINFLUX method” refers to localization and tracking methods for individual emitters in which light distributions of illumination light that excites light emissions from the emitter are generated at the focus in the sample, wherein the light distributions comprise a local minimum and in which the position of an individual emitter is determined by detecting light emissions from the emitter for different positions of the minima of the relevant light distributions or for different such light distributions in a close range of the emitter, wherein particular advantage is taken of the fact that the smaller the distance between the emitter and the minimum of the light distribution, the less light is emitted by the emitter.

In this application, the term “STED-MINFLUX method” refers to methods corresponding to the MINFLUX method as defined above, with the difference that instead of the intensity distribution of excitation light, there is an intensity distribution of emission inhibition light that overlaps with excitation light. The fact that the intensity distribution of emission inhibition light overlaps with excitation light means that the sample in the area of the intensity minimum and the adjacent sections of the intensity increase areas of the emission inhibition light, within which an emitter is located, is exposed to excitation light in such a way that emission of the emitter is excited or would be excited in the absence of emission inhibition light, so that the emission inhibition light, according to its intensity distribution, affects the stimulated emission or the stimulation of the emission in such a way that a measured emission of an emitter located within the intensity distribution of the emission inhibition light decreases with increasing distance from the intensity minimum. If the emission inhibition light is STED light and the emitter is a fluorescent emitter, this means that the spontaneous emission of the fluorescent emitter decreases with increasing distance from the intensity minimum of the STED light. As is customary in STED microscopy, the stimulated emission of the emitter, which has the same wavelength as the STED light, does not contribute to the measured emission; it is blocked, for example, by a filter. The fact that the intensity distribution of emission inhibition light overlaps with excitation light does not mean that the excitation light and the emission inhibition light are introduced into the sample strictly simultaneously. For example, as is common in STED microscopy, it is possible to apply a short pulse of excitation light, immediately followed by a pulse of STED light as emission inhibition light. The excitation light with which the intensity distribution of emission inhibition light overlaps may, for example, comprise an intensity distribution as is common in confocal microscopy, i.e., correspond at least approximately to an Airy function or a Gaussian function, wherein its central maximum may coincide with the minimum of the emission inhibition light. It may also correspond to a top hat function. Constant excitation in the wide field is also possible.

The term STED-MINFLUX is used in a generalized sense; it should not be understood to mean that the emission inhibition light must be STED light.

In MINFLUX microscopy and STED-MINFLUX microscopy, the sample is illuminated with focused illumination light, wherein the illumination light forms an intensity distribution with a central intensity minimum, in particular an intensity zero point, around a geometric focus in the sample. The position of a single emitter relative to the central minimum then determines the intensity or photon emission rate of the light emissions from the emitter, which is used to determine its position. Intensity distributions with a central minimum can be generated in particular by phase modulation of the illumination light using a phase filter or a spatial light modulator (SLM) in the illumination beam path, focusing of the illumination light using an objective lens and, if necessary, additional circular polarization of the illumination light. The intensity distribution is then created at the geometric focus by interference.

When this application refers to the intensity distribution being displaced to scanning positions, this means that the entire intensity distribution is displaced relative to the sample in such a way that the central minimum is located at a scanning position in each case.

In this application, a donut-shaped intensity distribution is understood to be a special form of intensity distribution with a central minimum, which has a minimum that is surrounded in all spatial directions within a given plane by intensity increase areas.

If this minimum extends along an axis perpendicular to this plane, this minimum is referred to in this application as a 2D minimum. A 2D minimum may be obtained, for example, by a vortex phase plate in the beam path, wherein the minimum may then extend, for example, along the optical axis of an objective lens. In this application, a 3D minimum is understood to be a minimum that is surrounded in all spatial directions by intensity increase areas. A 3D minimum may be obtained, for example, by superimposing two light beams, wherein the wavefront of one of the two beams is modulated in phase in one pupil using a so-called annular phase plate and that of the other using a vortex phase plate. A 3D minimum may also comprise a donut-shaped intensity distribution in a given plane. Modulating the wavefront with an annular phase plate alone (without superimposing a light beam modulated by a vortex phase plate) may also produce a 3D minimum, which is also known as a bottle beam.

In this application, the term “localization” describes a method for determining the position of a single emitter in a sample. In contrast to conventional light microscopy methods, this method does not require optical imaging of the sample. Instead, the MINFLUX localization method according to the present disclosure detects light emissions from the emitter for different positions of the intensity distribution of the illumination light and uses a position estimator to calculate the position of the emitter. This process may be performed sequentially for several single emitters, and the determined positions may be displayed in a localization map, which may result in a high-resolution light microscopic image.

Tracking an emitter refers to the sequential multiple localization of an emitter that moves within the sample. The corresponding positions may then be displayed, for example, as a trajectory.

In the context of this specification, the term “close range of an emitter” describes an area or volume (e.g., a circle or sphere) around the expected position of a single emitter. The expected position of the emitter may form the center of the area or volume. To determine the expected position, MINFLUX localization or localization using an independent method, in particular with lower accuracy, may be used (e.g., raster scan with minimum intensity distribution or regular focus, or PALM (Photoactivated Localization Microscopy)/STORM (Stochastic Optical Reconstruction Microscopy)-type localization). In particular, the close range has dimensions in the order of magnitude of the optical diffraction limit, i.e., the close range extends in one spatial direction (more specifically, in two spatial directions or in three spatial directions) no further than a low multiple of the diffraction limit (at a given wavelength of detection of the light emitted by the emitter), more particularly ten times, even more particularly five times, even more particularly twice, most particularly 1.5 times, the diffraction limit. In particular, the close range extends in at least one spatial direction no further than the diffraction limit. In particular, the diffraction limit may correspond to the diameter of an Airy disk. For example, in the case of two-dimensional localization of the emitter, the close range may be a circle with a diameter in the range from 100 nm to 2 μm, particularly 150 nm to 2 μm, more particularly 200 nm to 2 μm, even more particularly 250 nm to 2 μm, even more particularly 300 nm to 2 μm. According to a further example, in the case of two-dimensional localization, the close range may be a circle with a diameter in the range of 100 nm to 2 μm, particularly 100 nm to 1.5 μm, more particularly 100 nm to 1 μm, even more particularly 100 nm to 500 nm. Further examples are, in particular, circles with a diameter of 150 nm to 1.5 μm, 150 nm to 1.5 μm, 200 nm to 1.5 μm, 250 nm to 1.5 μm, 300 nm to 1.5 μm, 150 nm to 1 μm, 200 nm to 1 μm, 250 nm to 1 μm, 300 nm to 1 μm, 150 nm to 500 nm, 200 nm to 500 nm, 250 nm to 500 nm, or 300 nm to 500 nm. In particular, the center of the circle is located at the expected position of the emitter. In particular, in the case of three-dimensional localization, the close range may be a sphere with the above-mentioned diameters.

The close range comprises an inner region and an outer region. This means that the inner region and the outer region are disjoint sub-areas or sub-volumes of the close range, with the outer region enclosing the inner region. The inner region and the outer region do not have to completely cover the close range, i.e., there may be sub-areas or sub-volumes of the close range that do not belong to either the inner region or the outer region. In particular, the inner region borders on the outer region. Alternatively, there may also be a further sub-area or sub-volume of the close range between the inner region and the outer region. The inner region may be, for example, a circle or a sphere whose center is at the expected position of the emitter. In this case, the outer region may be, for example, a circular ring or a spherical shell with a center at the expected position of the emitter, which encloses the inner region, i.e., the inner region and the outer region may be bounded by concentric circles or concentric spheres around the center. As an alternative to circles, ellipses or other shapes, including irregular ones, are of course also possible. In the three-dimensional case, ellipsoids or ellipsoidal shells are also conceivable.

In the context of this specification, a measurement cycle is defined as a period of time during which the intensity distribution of the illumination light in the sample is displaced and emissions from the emitter to be located or tracked are detected, wherein the emissions are used to determine the position. Such position determination itself may take place during the measurement cycle, immediately after the measurement cycle, or after completion of an entire measurement (i.e., in particular, several measurement cycles). During the measurement cycle, the intensity distribution is displaced to scanning positions along a path, i.e., positioned at scanning positions that lie on the path. The entire path may be traversed in the measurement cycle. However, this is not absolutely necessary. A measurement cycle may also be terminated after traversing part of the path (e.g., three-quarters of the arc length of the path). This may be useful, for example, if the emissions detected at the scanning positions along the part of the path already allow the position of the emitter to be determined with sufficient accuracy. On the other hand, in some cases it may also be necessary or desirable to traverse the path multiple times in one measurement cycle or to traverse multiple measurement cycles for position determination, in particular to accumulate sufficient light emissions from the emitter. In the course of post-processing, additional scanning positions can be added to the scanning positions of a measurement cycle for a more refined position determination.

The light emissions from the emitter are detected by a measuring device. It may comprise, for example, a point detector such as an avalanche photodiode (APD), a photomultiplier or a hybrid detector, or a spatially resolving detector such as a camera or a so-called APD array. In particular, the measuring device also comprises evaluation electronics. In particular, the measuring device is configured to detect and register individual photons emitted by the emitter. The light emissions may be assigned to the scanning positions by synchronizing the measuring device with the beam scanner (and, if necessary, other scanning devices) so that, for a point in time at which light emissions are detected, it is possible to determine, at least approximately, the position at which the intensity distribution of the illumination light was at that point in time.

In the context of the present specification, a beam scanner is a device configured to displace the illumination light beam by one or more optical components so that the focus of the illumination light is displaced on or within the sample. In particular, the focus is displaced in two spatial directions, more particularly in a focal plane that is perpendicular to the optical axis of an objective lens. The spatial directions may be defined in a wide variety of coordinate systems, e.g., in Cartesian coordinates (e.g., x and y directions), in polar coordinates, or in spherical coordinates (e.g., radial and azimuthal directions). The beam scanner may be, for example, a mechanical scanner, an electro-optical deflector, or an acousto-optical deflector. In a mechanical scanner, the at least one optical component, e.g., a mirror, is moved, in particular rotated around one or more axes of rotation, to deflect the illumination light beam.

The beam scanner receives control signals, in particular electrical signals, from a control device, which influence a state of the at least one optical component to displace the illumination light beam to a desired position. If the beam scanner is a mechanical scanner with at least one movable optical component, the control signals are assigned nominal movements of the at least one optical component, which are determined by the control signals.

### Description

A first aspect of the present disclosure relates to a method for localizing or tracking an emitter (in particular, a method of localizing or tracking an emitter) in a sample using a MINFLUX method or a STED-MINFLUX method, wherein the sample is illuminated in a close range to the emitter by an illumination light beam having an intensity distribution of illumination light that comprises a central minimum, wherein the illumination light is excitation light or emission inhibition light, in particular STED light, and wherein the illumination light or another light excites the emitter to emit light. The intensity distribution is displaced during a measurement cycle to scanning positions by a beam scanner comprising at least one optical component that displaces the illumination light beam, wherein emissions from the emitter are detected for the scanning positions and assigned to the scanning positions.

In the event that the illumination light is emission inhibition light, the other light may be excitation light overlapping with the intensity distribution of the illumination light.

According to the present disclosure, the beam scanner is controlled by control signals to displace the intensity distribution along a path during the measurement cycle, wherein the intensity distribution is displaced along the path both to scanning positions in an outer region of the close range of the emitter and to scanning positions in an inner region of the close range of the emitter, wherein the scanning positions are arranged around an expected position of the emitter in the sample in at least two spatial directions, and wherein the control signals and/or nominal movements of the at least one optical component determined by the control signals can be described respectively or are described respectively as a function of time by a sine function or by a weighted sum of sine functions with a finite number of summands.

In a method of localization, it is also possible, in particular, to displace only the intensity distribution and to detect the light emissions of the emitter or different emitters and to perform the position determination after completion of the entire measurement. However, position determination during the measurement allows, for example, the performance of an iterative MINFLUX method, which improves the precision of the localization.

The sample is illuminated only in certain areas of the close range, but may also cover the entire close range.

The intensity distribution is moved as precisely as possible along a continuous path using the beam scanner. This may result in a deviation of the actual path from the desired path, particularly at higher scanning speeds. However, this deviation can be kept to a minimum due to the special control signals and the special path profile.

By using control signals or nominal movements of the at least one optical component consisting of sine functions or composed of sine functions, the scan bandwidth of the beam scanner (or, in particular in the case of a digital control, also the bandwidth of the control) can be utilized particularly well, i.e., a certain positional accuracy can be achieved at a higher scanning speed than, for example, with step-by-step control of the scanner. In contrast to so-called orbital tracking, in which the illumination light beam is scanned in a circle over the sample, the control signals or nominal movements are superimposed according to the present disclosure in such a way that the scanning positions lie on a path that covers both the outer region and the inner region of the close range of the emitter. In this way, a MINFLUX method can be performed that allows a similarly high positional accuracy for different actual emitter positions. Furthermore, in particular, several scanning patterns of different sizes, such as those used in iterative MINFLUX methods according to the prior art, can be scanned within one track in the method according to the present disclosure, which reduces the control effort.

Furthermore, the control according to the present disclosure also allows mechanical beam scanners, such as galvanometer scanners, to be used for MINFLUX microscopy without having to accept major disadvantages in terms of measurement time. This has the advantage of eliminating the need for complex and expensive electro-optical deflectors.

The control signals or the nominal movements can be described respectively as a function of time by a sine function or a weighted sum of sine functions. This naturally also includes cosine functions or weighted sums of cosine functions, since, as is well known to those skilled in the art, any cosine function can be converted into a sine function by a phase shift of π/2. The summands of the sums can be respectively positive or negative.

In the case of control signals, the function of time may, for example, describe a progression of current or electrical voltage over time to which the optical component or a component connected to the optical component is subjected, wherein the extent of the beam displacement depends monotonically on the current or voltage in a known manner. If the function describes the nominal movement, it particularly expresses a progression of a position of the optical component relative to a location coordinate (e.g., a rotation angle) overtime.

Since, according to the present disclosure, the intensity distribution describes a continuous path in the sample, the scanning positions are particularly determined by the measurement times and/or measurement signal integration times of the measuring device, similar to laser scanning microscopy. If the measurement signal integration times of the measuring device are short compared to the path speed, a scanning point corresponds to the point on the path at which the minimum of the intensity distribution was positioned at the measurement time. However, if the intensity distribution moves a non-negligible distance along the path during a measurement signal integration time, an arbitrarily selected point, e.g., the starting point, the end point, or the center of the path covered on the path, may be defined as the scanning point to which the emissions of the emitter recorded during the measurement signal integration time are assigned.

According to the present disclosure, the scanning positions are arranged in at least two spatial directions around an expected emitter position. This does not preclude a scanning position being located exactly at the expected emitter position, i.e., the path does not have to be located completely around the expected emitter position, but may pass through the expected emitter position. However, because the scanning positions are arranged in at least two spatial directions around the expected emitter position, the path cannot be a line on which the expected emitter position lies. The scanning positions may also be located in three spatial directions around the expected emitter position. In this case, three-dimensional localization or three-dimensional tracking of the emitter may be performed in particular. In particular, the projection of the path into a plane arranged around the projection of the emitter into the same plane.

According to an embodiment, the entire path is traversed at least once in the measurement cycle (in particular in each measurement cycle). This has the advantage that changes in the control of the scanning device (e.g., repositioning of the center of the path and/or scaling of the path) can always be performed at the same point on the path, which facilitates control of the scanning device. In addition, effects of asymmetries on the position estimation, e.g., with regard to a bias, can be avoided if necessary. Furthermore, a measurement cycle based on at least one complete path facilitates the calibration of a position estimator. In particular, exactly one path or an integer multiple of the path may be traversed in the measurement cycle.

According to an embodiment, the control signals and/or the nominal movements of the at least one optical component can be described respectively as a function of time by a sine function or a weighted sum of ten sine functions or less, particularly by a sine function or a weighted sum of four sine functions or less, more particularly by a sine function or a weighted sum of two sine functions. This simplifies the resulting paths and allows particularly simple and reliable control of the scanning device.

According to a further embodiment, the beam scanner is controlled by a first control signal and a second control signal, wherein the first control signal causes a displacement of the intensity distribution along a first spatial direction, and wherein the second control signal causes a displacement of the intensity distribution along a second spatial direction that is non-parallel to the first spatial direction, particularly perpendicular to it, wherein the first control signal and/or a first nominal movement of the at least one optical component determined by the first control signal and the second control signal and/or a second nominal movement of the at least one optical component determined by the second control signal can each be described as a function of time by a sine function or by a weighted sum of sine functions with a finite number of summands. The first and second spatial directions may be, for example, an x-direction and a y-direction (Cartesian coordinates) or a radial and an azimuthal direction (polar or spherical coordinates).

According to an embodiment, the first control signal and/or the first nominal movement of the at least one optical component can be described respectively as a function of time by a sine function or a weighted sum of ten sine functions or less, particularly by a sine function or a weighted sum of four sine functions or less, more particularly by a sine function or a weighted sum of two sine functions.

According to an embodiment, the second control signal and/or the second nominal movement of the at least one optical component can be described respectively as a function of time by a sine function or a weighted sum of ten sine functions or less, particularly by a sine function or a weighted sum of four sine functions or less, more particularly by a sine function or a weighted sum of two sine functions.

According to a further embodiment, the first control signal controls a first optical component of the beam scanner and the second control signal controls a second optical component of the beam scanner. The first optical component may be, for example, a first rotatable mirror of a galvanometer scanner, and the second optical component can be a second rotatable mirror of a galvanometer scanner.

According to a further embodiment, the first control signal and the second control signal jointly control an optical component of the beam scanner, further in particular wherein a first nominal movement of the optical component is assigned to the first control signal and a second nominal movement of the optical component is assigned to the second control signal. In this case, the optical component may be, for example, a mirror rotatable around two axes. Such a configuration is known, for example, in so-called MEMS scanners.

According to a further embodiment, the first control signal and/or the first nominal movement can be described or is described by the function x=Aₓ sin(ω₁ t+φ₁), wherein the second control signal and/or the second nominal movement can be described or is described by the function y=A_{y} sin(ω₂t+φ₂), wherein Aₓ denotes an amplitude of the first control signal and/or the first nominal movement, wherein A_{y} denotes an amplitude of the second control signal and/or the second nominal movement, wherein t denotes the time, wherein ω₁ denotes a frequency of the first control signal and/or the first nominal movement, wherein ω₂ denotes a frequency of the second control signal and/or the second nominal movement, wherein φ₁ denotes a phase of the first control signal and/or the first nominal movement, and wherein φ₂ denotes a second phase of the second control signal and/or the second nominal movement.

The frequency of the first control signal and/or the first nominal movement is unequal to the frequency of the second control signal and/or the second nominal movement. Thus, the resulting path is particularly not a circle. In particular, the phase of the first control signal and/or the first nominal movement is equal to the phase of the second control signal and/or the second nominal movement, or their phase difference is zero. In particular, the phase of the first control signal and/or the first nominal movement and the phase of the second control signal and/or the second nominal movement are both equal to zero.

Under these conditions, the path of the intensity distribution in the sample resulting from the superposition of the two sinusoidal control signals and/or nominal movements is, in particular, a Lissajous figure. Such paths are characterized in that the inner region and the outer region of the close range are covered and that the scanning device can control the paths with sufficient accuracy even at high speeds. Furthermore, such figures are point-symmetrical with respect to a center that may be positioned, for example, at an expected emitter position. According to a further embodiment, the amplitude of the first control signal and/or the first nominal movement is equal to the amplitude of the second control signal and/or the second nominal movement. This leads in particular to a path that approximately fills a circle, which has advantages for position determination.

According to a further embodiment, a ratio between the frequency of the first control signal and/or the first nominal movement and the frequency of the second control signal and/or the second nominal movement is a rational number unequal to 1. In particular, this leads to the resulting path being closed, i.e., the position of the path relative to the sample remains the same even after several passes. This reduces the computational effort required for position determination, since the distribution of the scanning points may be kept constant in all passes of the path with the parameters remaining unchanged. Furthermore, this makes it easier to compare different localizations. Rational ratios are, for example, 2:1, 3:1, 3:2, 4:3, etc.

According to a further embodiment, the first control signal and/or the first nominal movement can be described by the function

$$x = {A}_{1}^{x} sin ( {ω}_{1}^{x} t + {φ}_{1}^{x} ) ∓ {A}_{2}^{x} sin ( {ω}_{2}^{x} t + {φ}_{2}^{x} ) ,$$

wherein the second control signal and/or the second nominal movement can be described by the function y=

$${A}_{1}^{y} sin ( {ω}_{1}^{y} t + {φ}_{1}^{y} ) ∓ {A}_{2}^{y} sin ( {ω}_{2}^{y} t + {φ}_{2}^{y} ) , wherein {A}_{1}^{x}$$

denotes a first amplitude of the first control signal and/or the first nominal movement, wherein

$${A}_{2}^{x}$$

denotes a second amplitude of the first control signal and/or the first nominal movement, wherein

$${A}_{1}^{y}$$

denotes a first amplitude of the second control signal and/or the second nominal movement, wherein

$${A}_{2}^{y}$$

denotes a second amplitude of the second control signal and/or the second nominal movement, wherein t denotes the time, wherein

$${ω}_{1}^{x}$$

denotes a first frequency of the first control signal and/or the first nominal movement, wherein

$${ω}_{2}^{x}$$

denotes a second frequency of the first control signal and/or the first nominal movement, wherein

$${ω}_{1}^{y}$$

denotes a first frequency of the second control signal and/or the second nominal movement, wherein

$${ω}_{2}^{y}$$

denotes a second frequency of the second control signal and/or the second nominal movement, wherein

$${φ}_{1}^{x}$$

denotes a first phase of the first control signal and/or the first nominal movement, wherein

$${φ}_{2}^{x}$$

denotes a second phase of the first control signal and/or the first nominal movement, wherein

$${φ}_{1}^{y}$$

denotes a first phase of the second control signal and/or the second nominal movement, and wherein

$${φ}_{2}^{y}$$

denotes a second phase of the second control signal and/or the second nominal movement. According to this embodiment, the amplitudes correspond to the weights of a weighted sum of sine functions with two summands or can be converted into such weights by normalization.

According to a further embodiment, the first frequency of the first control signal and/or the first nominal movement is equal to the first frequency of the second control signal and/or the second nominal movement. According to a further embodiment, the second frequency of the first control signal and/or the first nominal movement is equal to the second frequency of the second control signal and/or the second nominal movement.

According to a further embodiment, the first amplitude of the first control signal and/or the first nominal movement is equal to the first amplitude of the second control signal and/or the second nominal movement. According to a further embodiment, the second amplitude of the first control signal and/or the first nominal movement is equal to the second amplitude of the second control signal and/or the second nominal movement. According to a further embodiment, the first amplitude of the first control signal and/or the first nominal movement is equal to the second amplitude of the first control signal and/or the first nominal movement. According to a further embodiment, the first amplitude of the second control signal and/or the second nominal movement is equal to the second amplitude of the second control signal and/or the second nominal movement. According to a further embodiment, the first amplitude of the first control signal and/or the first nominal movement, the second amplitude of the first control signal and/or the first nominal movement, the first amplitude of the second control signal and/or the second nominal movement, and the second amplitude of the second control signal and/or the second nominal movement are equal in magnitude.

In particular, equal amplitudes of the control signals lead to paths in which the scanning points are distributed within a circle. This has advantages for MINFLUX localizations of stationary emitters in terms of position estimation, since the scanning pattern is usually centered on a pre-estimated position of the emitter. When tracking emitters (MINFLUX tracking) that move in a known spatial direction, in particular uniformly, it may also be advantageous to select the amplitudes of the movement in a first spatial direction to be greater than the amplitudes of the movement in a second spatial direction, and thus to arrange the scanning points within an ellipse whose major axis is parallel to the direction of movement.

According to a further embodiment, the first amplitude of the first control signal and/or the first nominal movement, the first amplitude of the second control signal and/or the second nominal movement, the second amplitude of the first control signal and/or the first nominal movement, and the second amplitude of the second control signal and/or the second nominal movement are identical.

According to a further embodiment, a ratio between the first frequency and the second frequency of the first control signal and/or the first nominal movement and/or a ratio between the first frequency and the second frequency of the second control signal and/or the second nominal movement is a rational number unequal to 1. In particular, this results in closed paths, which simplifies position determination, since the scanning positions may be kept constant during multiple passes of the path.

In particular, the path of the intensity distribution in the sample resulting from the superposition of the two control signals and/or nominal movements, each of which can be represented as the sum of two sine functions, is an epitrochoid or a hypertrochoid.

In the case of epitrochoids, the first control signal or the first nominal movement may be represented by the function x=A₁ cos(ω₁ t)−A₂ cos(ω₂t) and the second control signal or the second nominal movement by the function y=A₁ sin(ω₁ t)−A₂ sin(ω₂t), wherein A₁ denotes a first amplitude, A₂ denotes a second amplitude, t denotes the time, ω₁ denotes a first frequency, and ω₂ denotes a second frequency. These functions are equivalent to the general form of sums of sine functions with two summands shown above if the first summand of the sum respectively has a positive sign and the second summand of the sum respectively has a negative sign, and the following restrictions on the general equations apply:

$${A}_{1}^{x} = {A}_{1}^{y} ; {A}_{2}^{x} = {A}_{2}^{y} ; {ω}_{1}^{x} = {ω}_{1}^{y} ; {ω}_{2}^{x} = {ω}_{2}^{y} ; {φ}_{1}^{x} = {φ}_{2}^{x} ; {φ}_{1}^{y} = {φ}_{2}^{y} ; {φ}_{1}^{x} - {φ}_{1}^{y} = π / 2.$$

For hypotrochoids, the first control signal or the first nominal movement may be represented by the function x=A₁ cos(ω₁t)+A₂ cos(ω₂t) and the second control signal or the second nominal movement may be represented by the function y=A₁ sin(ω₁ t)−A₂ sin(ω₂t), wherein A₁ denotes a first amplitude, A₂ denotes a second amplitude, t denotes the time, ω₁ denotes a first frequency, and ω₂ denotes a second frequency. These functions are equivalent to the general form of sums of sine functions with two summands shown above, if both summands of the sum are positive for the first control signal or the first nominal movement, the first summand of the sum is positive for the second control signal or the second nominal movement, and the second summand of the sum has a negative sign for the second control signal or the second nominal movement, and the following restrictions of the general equations apply:

$${A}_{1}^{x} = {A}_{1}^{y} ; {A}_{2}^{x} = {A}_{2}^{y} ; {ω}_{1}^{x} = {ω}_{1}^{y} ; {ω}_{2}^{x} = {ω}_{2}^{y} ; {φ}_{1}^{x} = {φ}_{2}^{x} ; {φ}_{1}^{y} = {φ}_{2}^{y} ; {φ}_{1}^{x} - {φ}_{1}^{y} = π / 2.$$

Special forms of hypotrochoids are rosettes (also known as cloverleaf curves), hypocycloids, and epicycloids. In rosettes, there is a fixed relationship between the first frequency and the second frequency, wherein these are particularly a ratio that is equal to a rational number unequal to 1. In hypocycloids and epicycloids, there is a fixed relationship between amplitudes and frequencies.

In so-called loops, the first control signal or the first nominal movement may be represented by the function x=A₁ cos(ω₁ t)+A₂ cos(ω₂t) and the second control signal or the second nominal movement may be represented by the function y=A₁ sin(ω₁ t)+A₂ sin(ω₂t), wherein A₁ denotes a first amplitude, A₂ denotes a second amplitude, t denotes the time, ω₁ denotes a first frequency, and ω₂ denotes a second frequency. These functions are equivalent to the general form of sums of sine functions with two summands shown above if all summands have a positive sign and the following restrictions on the general equations apply:

$${A}_{1}^{x} = {A}_{1}^{y} ; {A}_{2}^{x} = {A}_{2}^{y} ; {ω}_{1}^{x} = {ω}_{1}^{y} ; {ω}_{2}^{x} = {ω}_{2}^{y} ; {φ}_{1}^{x} = {φ}_{2}^{x} ; {φ}_{1}^{y} = {φ}_{2}^{y} ; {φ}_{1}^{x} - {φ}_{1}^{y} = π / 2.$$

The loops include, for example, Pascal's screws.

According to a further embodiment, the at least one sine function (which describes a control signal and/or a nominal movement) has a time-constant frequency and/or a time-constant amplitude over the measurement cycle. This means that, in particular in the case of a sum of several sine functions describing a control signal or a nominal movement, all these sine functions have a constant frequency and/or a constant amplitude over the measurement cycle. In particular, both the frequency and the amplitude may be constant overtime. This excludes spiral paths. Nominal movements with constant frequencies and/or amplitudes can be executed particularly accurately and stably, particularly with mechanical scanners, at high scanning speeds.

According to a further embodiment, the scanning device is a mechanical scanner. Such scanners comprise movable, in particular rotatable or pivotable, optical components, e.g., mirrors or prisms. According to a further embodiment, the at least one optical component is a movable mirror, in particular a flat mirror.

Mechanical scanners may be operated resonantly or non-resonantly. Resonant mechanical scanners have certain desired resonant frequencies at which they are operated. Non-resonant mechanical scanners include galvanometer scanners, in which a galvanometer drive is typically coupled to a mirror respectively, so that an angle of the mirror around the axis of rotation can be set by a current signal fed into the galvanometer coils. In galvanometer scanners, the axes of rotation of the mirrors are typically not parallel to the optical axis of the incident light beam. At least one movable mirror coupled to a galvanometer drive is provided for each spatial direction in which the beam is to be deflected. Furthermore, mechanical scanners with so-called Risley prism pairs are known, in which the illumination beam passes successively through two wedge-shaped prisms that rotate around parallel axes of rotation.

Mechanical scanners are typically less expensive, simpler in design, and more robust than, for example, electro-optical or acousto-optical scanners, which are used in prior art MINFLUX microscopes. Mechanical scanners can be controlled quickly and accurately using the method according to the present disclosure to arrange the intensity distribution of the illumination light at scanning positions that cover both the inner and outer regions of the close range of the emitter. Mechanical scanners operated using the method according to the present disclosure thus enable a particularly simple, robust, and cost-effective implementation of a MINFLUX method.

Alternatively, the method according to the present disclosure with the advantages described above may of course also be carried out with electro-optical or acousto-optical scanners. According to one embodiment, the beam scanner is an electro-optical deflector or an acousto-optical deflector. Electro-optical deflectors that are controlled by sine signals enable greater beam deflections in relation to the control voltages than those with which the scanning points are controlled arbitrarily.

According to a further embodiment, the intensity distribution is displaced by rotational movements of the at least one optical component of the beam scanner around an axis of rotation or several axes of rotation, in particular wherein the optical component is a mirror or a prism.

According to a further embodiment, the beam scanner comprises a first optical component (in particular a first mirror or a first prism) that is rotatable around a first axis of rotation, and a second optical component (in particular a second mirror or a second prism) that is rotatable around a second axis of rotation, wherein the intensity distribution is displaced in a first spatial direction by a first rotational movement of the first optical component around the first axis of rotation, and wherein the intensity distribution is displaced in a second spatial direction, which is non-parallel, in particular perpendicular, to the first spatial direction, by a second rotational movement of the second optical component around the second axis of rotation, so that the intensity distribution is displaced on the path by a superposition of the first rotational movement and the second rotational movement, wherein first control signals and/or first nominal movements of the first optical component and second control signals and/or second nominal movements of the second optical component can each be described by sine functions or weighted sums of sine functions with a finite number of summands.

A rotational movement within the meaning of the present specification may comprise at least one complete rotation of 360° around the axis of rotation or a rotation of a partial angle of 360°. The latter is also referred to as a pivot movement in technical terminology.

In particular, the first axis of rotation and the second axis of rotation are non-parallel to each other.

In particular, the first optical component and the second optical component are arranged one behind the other in an illumination beam path, so that the illumination light beam is deflected successively by the first optical component and the second optical component. The beam scanner may comprise further optical components, e.g., further rotatable mirrors coupled to galvanometer drives. For example, so-called quad scanners are known, which comprise four independently rotatable mirrors, each coupled to galvanometer drives, of which two mirrors deflect the light beam in a first spatial direction (x-direction) and the other two mirrors deflect the light beam in a second direction (y-direction) perpendicular to the first direction.

To perform a MINFLUX or STED-MINFLUX method using an objective lens through which the illumination light is directed into the sample, the illumination light beam is particularly only tilted by the beam scanner in the pupil of the objective lens and is not displaced, or at least displaced as little as possible, since a displacement of the illumination light beam in the pupil would change the shape of the intensity distribution of the illumination light in the focus area and thus also the shape of the central minimum of the intensity distribution, which could have a negative effect on the accuracy of the localization. Beam scanners that deflect the illumination light beam in a manner that satisfies the above condition may, for example, comprise a mirror rotatable around two axes of rotation, which is located in a pupil plane, i.e., in a plane in which the pupil of the objective lens is imaged. Another possibility is a so-called quad scanner with two independently rotatable mirrors for each spatial direction of deflection, wherein the deflection of the beam for each spatial direction is performed by controlling the two mirrors in such a way that the deflected beam passes through a fixed point of the pupil, in particular the center of the pupil.

According to a further embodiment, the beam scanner comprises two optical components, which are configured as two separate rotatable mirrors, for displacing the intensity distribution in the sample in one direction. In particular, it comprises two rotatable mirrors for each of two spatial directions, which are particularly orthogonal to each other. The latter arrangement is known in the prior art as a quad scanner.

According to a further embodiment, the beam scanner is a galvanometer scanner with rotatable mirrors coupled to galvanometer drives.

According to a further embodiment, the beam scanner comprises one or more rotatable mirrors coupled to galvanometer drives and at least one rotatable mirror coupled to a resonant drive. With this combination of galvanometer scanner and resonant scanner, the resonant scanner can, for example, displace the intensity distribution at a higher frequency in a first spatial direction, and the galvanometer scanner can displace the intensity distribution at a lower frequency in a second spatial direction (which is non-parallel, in particular perpendicular to the first spatial direction). A resonantly driven rotatable mirror that displaces the intensity distribution in the first spatial direction may, for example, be located in a pupil plane of the objective lens, particularly wherein a further pupil plane is arranged between two rotatable mirrors of the galvanometer scanner that displaces the intensity distribution in the second spatial direction.

If the bandwidth of the resonant scanner is significantly higher than the bandwidth of the galvo scanner, it may be advantageous to drive the resonant scanner at a significantly higher frequency or frequencies than the galvo scanner. In this case, one of the paths described in this specification may be generated with a corresponding frequency ratio, for example.

According to a further embodiment, the beam scanner comprises an optical component, e.g., a mirror, which is rotatable around a first axis of rotation and around a second axis of rotation, wherein the intensity distribution is displaced in a first spatial direction by a first rotational movement of the optical component around the first axis of rotation and in a second spatial direction, which is non-parallel, in particular perpendicular, to the first spatial direction, by a second rotational movement of the optical component around the second axis of rotation, so that the intensity distribution is displaced on the path by a superposition of the first rotational movement and the second rotational movement, wherein the first control signals controlling the first rotational movement and/or first nominal movements of the optical component around the first axis of rotation and the second control signals controlling the second rotational movement and/or second nominal movements of the optical component around the second axis of rotation can each be described by sine functions or weighted sums of sine functions with a finite number of summands.

According to an embodiment, the beam scanner is a MEMS scanner with a mirror that is rotatable around two axes of rotation. In particular, such scanners are also available as resonant scanners with high bandwidth.

According to a further embodiment, the beam scanner comprises at least two optical components (in particular, rotatable mirrors arranged one behind the other in an illumination beam path) which are configured to displace the intensity distribution in the same spatial direction in the sample, wherein only one of the at least two optical components is controlled by the sinusoidal control signals or control signals that can be described as weighted sums of sinusoidal functions to displace the intensity distribution along the path in the measurement cycle, in particular wherein the at least one further optical component is kept at rest or controlled by a further control signal. The optical component controlled by the further control signal can, for example, perform a periodic movement with a lower amplitude and/or a lower frequency or a non-periodic movement. In scanners with several optical components arranged one behind the other in the illumination beam path, one of the optical components, for example, can achieve the same amplitude of the nominal movement in the sample with a smaller angular deflection (in other words, a smaller stroke) than the other optical component due to its arrangement in the optical system. In such cases, a higher frequency and thus a higher scanning speed may be achieved by controlling only one of the optical components.

According to a further embodiment, the beam scanner comprises a first rotatable mirror and a second rotatable mirror, wherein the beam scanner is configured to displace the intensity distribution along a first direction in the sample by cooperating rotational movements of the first rotatable mirror around a first axis of rotation and the second rotatable mirror around a second axis of rotation, particularly wherein the first axis of rotation is parallel to the second axis of rotation.

According to a further embodiment, the beam scanner further comprises a third rotatable mirror and a fourth rotatable mirror, wherein the beam scanner is configured to displace the intensity distribution along a second direction, which is non-parallel, in particular perpendicular, to the first direction, particularly wherein the third axis of rotation is parallel to the fourth axis of rotation.

According to a further embodiment, the beam scanner is configured to displace the illumination light beam in such a way that, during the displacement of the intensity distribution in an image plane of an objective lens focusing the illumination light beam into the sample, the illumination light beam remains stationary in a pupil of the objective lens (i.e., it is merely tilted), wherein the image plane is conjugate to a focal plane in the sample, and wherein a beam axis of the illumination light beam intersects or coincides with an optical axis of the objective lens in the image plane.

According to a further embodiment, the first rotatable mirror has a greater distance from the image plane than the second rotatable mirror, in particular wherein the third rotatable mirror has a greater distance from the image plane than the fourth rotatable mirror.

According to a further embodiment, one of the rotatable mirrors is arranged in a pupil plane of an objective lens focusing the illumination light beam into the sample, wherein the pupil plane is conjugate to a rear aperture of the objective lens.

According to a further embodiment, a pupil plane of an objective lens focusing on the sample is arranged between several rotatable mirrors of the beam scanner, wherein the pupil plane is conjugate to a rear aperture of the objective lens.

According to one embodiment, the beam scanner comprises two rotators, each coupled to a dispersive and/or reflective optical element, wherein the rotators rotate around, particularly parallel, axes of rotation. The axes of rotation may each be arranged parallel to an optical axis of the illumination light beam. Such scanners are also referred to as Risley prism pair scanners in the case where the dispersive elements are wedge-shaped prisms. Such scanners can generate the paths described in this specification at high speed. However, in the case of dispersive elements, the beam deflection is wavelength-dependent. Therein, the deflection by the two optical elements occurs in a radial direction and an azimuthal direction.

The beam scanner may also comprise a combination of a dispersive and/or reflective optical element rotatable around a first axis of rotation and an optical component (in particular a mirror coupled to a galvanometer drive) rotatable around a second axis of rotation, wherein the first axis of rotation is parallel to the optical axis of the illumination light beam, and wherein the second axis of rotation is non-parallel to the first axis of rotation.

According to a further embodiment, the frequency spectra of the functions describing the first rotational movements, normalized to their maximum, comprise an identical first normalized frequency power spectrum, wherein the frequency spectra of the functions describing the second rotational movements, normalized to their maximum, comprise an identical second normalized frequency power spectrum.

According to a further embodiment, the first and second normalized frequency power spectra are identical to each other.

According to a further embodiment, the path of the intensity distribution in the sample is closed. A closed path can be generated, for example, by generating Lissajous figures or hypotrochoids with a fixed, rational frequency ratio. Closed paths have the particular advantage that the scanning positions can be selected identically for several successive passes, which facilitates position determination.

According to a further embodiment, the path is point- or rotationally symmetric with respect to an expected position of the emitter. This has the advantage that the detected light emissions are comparable for all actual positions of the emitter relative to an expected position of the emitter. This results in improved position estimation.

According to a further embodiment, the path is axially symmetric with respect to a straight line on which an expected position of the emitter lies. This embodiment can be advantageous, for example, if it is known that the emitter moves parallel to the straight line.

According to a further embodiment, at least a subset of the scanning positions is arranged at least approximately rotationally symmetrical around an expected position of the emitter. This has the advantage that the detected light emissions are comparable for all actual positions of the emitter relative to an expected position of the emitter. This results in improved position estimation.

According to a further embodiment, the path crosses the inner region and/or the outer region several times during a measurement cycle. In this way, in particular already the scanning points resulting from a single pass of the path can be selected with particular flexibility.

According to a further embodiment, the path comprises a center, in particular wherein the center is a center of gravity of the path and/or a center of symmetry of the path. In particular, the center is located at an expected position of the emitter. This embodiment has the advantage that a scanning position can be selected in the center. This position can be used either for position determination or for determining a control value for background correction of the position determination, which exploits the fact that the signal above the background is lower the closer a scanning position is to the actual emitter position.

According to a further embodiment, a position of the emitter is estimated from the emissions of the emitter associated with the scanning positions. This can be done, for example, in a manner known from the prior art using a position estimator, e.g., a least-mean-squares estimator or a maximum-likelihood estimator. In MINFLUX localization, the emissions (i.e., the intensity or photon rate) are higher the further the actual emitter position is from the position of the minimum of the (excitation) intensity distribution. In STED-MINFLUX localization, on the other hand, the emissions are higher the closer the emitter is to the position of the minimum of the (STED) intensity distribution.

According to a further embodiment, the position of the emitter in the measurement cycle is estimated from a plurality of emissions, in particular a plurality of photons, from the emitter and a plurality of scanning positions assigned to the emissions. In particular, the plurality of emissions and the plurality of assigned scanning positions may be used as input values for a position estimator. Each emission is assigned to a respective scanning position. The position estimator may be based, for example, on a vector sum of the position vectors of the scanning positions weighted by the emissions.

According to a further embodiment, the position estimation is performed in the measurement cycle after detecting a plurality of emissions from the emitter. According to this embodiment, therefore, not every light emission is responded to with an adjustment of the estimated position.

By processing multiple emissions, a higher positional accuracy can be achieved with a slight deterioration in time resolution.

According to a further embodiment, after the measurement cycle, a further measurement cycle is performed, wherein the path for the further measurement cycle is shifted and/or scaled relative to the sample based on an emitter position estimated in the previous measurement cycle. In this way, for example, an iterative MINFLUX method can be implemented. Therein, the position of the emitter is determined repeatedly, wherein, for example, a center of the path is arranged at the last determined emitter position after a position determination. Optionally, during this repositioning, the pattern of the scanning positions, i.e., in this case the path, may be reduced, in particular by decreasing the amplitudes of the sine functions. This increases the positional accuracy of the localization, provided that the emitter is located in a so-called catch range of the localization, in which it can be unambiguously localized. The light intensity of the illumination light may be increased to achieve a similarly high photon rate despite the smaller distance of the emitter from the minimum of the intensity distribution. As an alternative to this method, scaling of the path may also be performed without repositioning.

The subsequent measurement cycle may be used as described above to more accurately localize the emitter whose emissions were already recorded in the previous measurement cycle. Another option is to shift (with or without scaling) the position of the path when tracking a moving emitter in the sample (MINFLUX tracking). Therein, in particular, the position of the path may be shifted after determining the position along the direction of movement of the emitter (determined from the previous measurement points).

According to a further embodiment, before the further measurement cycle, parameters of the functions describing the control signals and/or nominal movements of the at least one optical component displacing the intensity distribution are adjusted in such a way that a smaller area is scanned in the further measurement cycle.

According to a further embodiment, the control signals for the further measurement cycle are adjusted based on the emitter position estimated in the previous measurement cycle. For example, amplitudes, phases, or frequencies of the sine functions may be adjusted to adjust the path, or, e.g., further sine functions may be added to the function. In particular, the control signals may also be changed, for example, so that different path shapes are switched between, for example, from a Lissajous curve to a rosette.

According to a further embodiment, a drive signal may be applied to the at least one optical component of the beam scanner or a further optical component of the beam scanner or a displacement unit before and/or after the measurement cycle to shift the position of the path relative to the sample. The movement of the intensity distribution along the path is superimposed with a movement caused by the drive signal. The displacement unit can be, for example, another beam scanner (in particular a mechanical scanner, such as a galvo scanner or a piezo scanner, a deformable mirror, an EOD or an AOD). Alternatively, the displacement unit may displace the sample relative to the objective of the MINFLUX microscope. In the latter case, the displacement unit may be, for example, a piezo scanner or piezo actuator coupled to a sample table. The drive signal may be used to center the path on a newly determined emitter position, for example, in an iterative MINFLUX process.

According to a further embodiment, the shift of the path relative to the sample and/or a scaling of the path is performed at a predetermined point of the path, in particular wherein the predetermined point is selected such that a minimum acceleration and/or a minimum jerk of the at least one optical component results and/or such that a relaxation process of the at least one optical component is optimized, in particular time-optimized. Therein, the jerk is the change in acceleration, i.e., the third derivative of the position curve with respect to time. A predetermined point refers to a point that has already been defined for a specific path before the measurement or before the measurement cycle is performed. Of course, there may also be several predetermined points. In this case, the shift and/or scaling is performed in particular at the next predetermined point reached by the minimum of the intensity distribution when traveling along the path. When determining the predetermined points, a response time of the beam scanner may be taken into account if it is not small compared to the speed of the intensity distribution along the path.

For example, the predetermined points may be zero crossings, i.e., points at which the position of the minimum of the intensity distribution of the illumination light in one spatial direction or in several spatial directions lies on an axis of a coordinate system. A zero crossing in two or three spatial directions is then a zero point that may, for example, form a center of the path. In the case of a mechanical beam scanner, shifting or scaling at such a zero crossing has the particular advantage that the optical component or the respective optical component is unaccelerated when this point is reached.

Another possibility is to perform shifts of the position of the path in a desired direction at points on the path where the intensity distribution is already moving approximately in the desired direction. Such a point could be, for example, a point on the path whose tangent runs in the desired direction. In this way, the acceleration required to shift the position of the path can be minimized for mechanical scanners.

After a shift or scaling, the beam scanner or the at least one optical component may comprise a relaxation time during which the path traced by the intensity distribution in the sample deviates (significantly, not negligibly) from the desired new path. In particular, the predetermined points for a specific path may be selected so that the relaxation time is minimal.

According to a further embodiment, the sample is illuminated with the intensity distribution of the illumination light in at least one background detection step, wherein the intensity distribution is displaced along a path by the beam scanner, and wherein a background value is determined based on light emitted from the sample and detected by a measuring device. Therein, the path is selected so that the intensity distribution is displaced to scanning positions that are outside the close range of light-emitting emitters in the sample that are to be localized or tracked.

In the background detection step, light is therefore detected at positions where no light emissions from emitters to be localized or tracked are expected at the time of the background detection step. This may happen, for example, during a search and/or pre-localization step, in which the sample is illuminated with the illumination light at different positions of a search grid to locate individual emitters and determine their approximate position, and then to perform a MINFLUX procedure based on this approximate position. The light emissions detected during a specified illumination period may be counted and compared with a threshold value-if the number of detected light emissions is below the threshold value, it may be assumed that this is background light and that there is no light-emitting emitter at the corresponding position. In this case, the detected light emissions may be used to determine the background value.

A search and/or pre-localization step may be performed, for example, as described in the prior art, by pinhole orbit scanning (see US 2023/0251479 A1) or by a raster scan.

Optionally, after comparison with the threshold value, different paths, e.g., paths of different sizes, may be traversed to determine background values for the respective paths. The illumination light may optionally have different total intensities for the different paths, in particular greater total intensities for smaller paths.

In particular, the paths used in the background detection step may be the same paths that are also used in the measurement cycle. In this way, a background value may be determined specifically for each path, e.g., to improve position determination by an iterative MINFLUX method.

In principle, it is also possible to determine a background value in the background detection step at a location in the sample where an emitter to be localized or tracked is located, as long as this emitter is in a non-emitting dark state during the background detection step.

In particular, following a measurement cycle in which an emitter is bleached or transitions to a non-emitting dark state, a background detection step may be performed at the same position in the sample.

According to a further embodiment, a position estimator is adjusted for at least one measurement cycle based on the determined background value.

This may be done, for example, by subtracting the background value from the denominator of a position estimator based on a vector sum. The background value may be subtracted from the sum of the light emissions, in particular single photons, detected during the measurement cycle (for different scanning positions). Such a correction is described, for example, in US 2022/0042914 A1. In particular, light emissions detected at a center of the path (if the path passes through the center) are not taken into account in the background correction to avoid the problems that would otherwise arise in the background correction. However, background correction is not limited to a vector sum or a least-means-square estimator, but may be performed with any position estimator, e.g., also a maximum-likelihood estimator.

In particular, measurement data from several previous background detection steps may be used to determine a background value and/or to determine the threshold value for distinguishing between signal and background, e.g., in the form of a continuously updated histogram (see US 2022/0042914 A1), wherein a position estimator for one or more measurement cycles is adjusted using the background value.

A second aspect of the present disclosure relates to a MINFLUX microscope for localizing or tracking an emitter (particularly configured for localizing or tracking an emitter), in particular according to a method according to the first aspect, comprising a light source configured to generate an illumination light beam, an illumination optic configured to illuminate a sample in a close range of an emitter with an intensity distribution of illumination light comprising a central minimum by the illumination light beam, wherein the illumination light is excitation light or emission inhibition light, in particular STED light, and wherein the illumination light or another light excites the emitter to emit light, a beam scanner comprising an optical component that displaces the illumination light beam, wherein the beam scanner is configured to displace the intensity distribution to scanning positions during a measurement cycle, and a measuring device that is configured to detect emissions from the emitter for the scanning positions.

According to the present disclosure, the MINFLUX microscope comprises a control unit that is configured to control the beam scanner with control signals to displace the intensity distribution along a path during the measurement cycle, so that the intensity distribution is displaced along the path both to scanning positions in an outer region of the close range of the emitter and to scanning positions in an inner region of the close range of the emitter, wherein the scanning positions are arranged around an expected position of the emitter in the sample in at least two spatial directions, wherein the control signals and/or nominal movements of the at least one optical component can be described respectively as a function of time by a sine function or by a weighted sum of sine functions with a finite number of summands.

The other light is, in the case wherein the illumination light is STED light, in particular excitation light overlapping with the intensity distribution of the illumination light.

The control unit may be a conventional computer designed for various tasks or a specialized control device, e.g., a microprocessor, a field programmable gate array (FPGA), or an application specific integrated circuit (ASIC). The control unit may form a common unit with the computing unit or be implemented separately from the computing unit.

According to an embodiment, the MINFLUX microscope comprises a computing unit that is configured to estimate the position of the emitter from the emissions of the emitter assigned to the scanning positions. For this purpose, the computing unit may execute a position estimation algorithm implemented in hardware or software, in which, for example, as known from the prior art, a least-mean-square estimator or a maximum-likelihood estimator is used.

According to a further embodiment, the illumination optic comprises an objective lens that is configured to focus the illumination light beam into the sample and/or to collect the emissions emanating from the emitter into a detection light beam.

According to a further embodiment, the illumination optic comprises a light modulator that is configured to modulate an amplitude and/or a phase of the illumination light so that the intensity distribution of the illumination light with the local minimum is formed at a focus in the sample. The light modulator may be, for example, a phase filter or a phase plate with a fixed phase pattern, or a controllable spatial light modulator (e.g., of the liquid crystal type) in which the phase pattern displayed can be changed by control commands. Such a light modulator may be operated in transmission mode, reflection mode, or diffraction mode. In the latter case, in particular, the phase pattern may be superimposed with a diffraction grating.

In particular, the light source may be a continuous or pulsed laser. If the MINFLUX microscope is configured to perform a STED-MINFLUX process, a STED laser may be provided in addition to an excitation laser. Alternatively, excitation and STED light may also be coupled out from a white light source in a known manner.

In particular, the beam scanner may be a mechanical scanner (in particular a galvanometer scanner, a resonant mechanical scanner, a combination of a galvanometer scanner and a resonant scanner, a MEMS scanner, a Risley prism pair scanner, or a piezo scanner, or a combination of a dispersive element rotating around an axis of rotation parallel to the optical axis of the illumination light beam and a galvanometer mirror rotatable around another axis of rotation). In particular, the at least one optical component may be a mirror or a prism.

In particular, the illumination optic may comprise a beam splitter, e.g. a dichroic mirror, for separating the emission light emanating from the sample from the illumination light. The beam scanner may be arranged between the beam splitter and the objective lens, so that the emission light emitted by the sample is de-scanned by the beam scanner. Alternatively, the beam scanner may be located between the light source and the beam splitter so that the emission light is directed to the detector without being de-scanned (non-de-scanned configuration).

In addition to the beam scanner, the MINFLUX microscope may optionally comprises a further displacement device, e.g., a deformable mirror or a further beam scanner (such as a galvanometer scanner or an electro-optical or acousto-optical deflector), which displaces the illumination light and/or the emission light.

According to a further embodiment, the measuring device is a point detector (particularly an avalanche photodiode, APD, a photomultiplier, or a hybrid detector) or a spatially resolving detector (in particular a camera, more specifically a CMOS or CCD camera, or an array of point detectors such as APDs, photomultipliers, or hybrid detectors). The measuring device may be arranged confocally, i.e., in an image plane conjugate to a focal plane in the sample. For this purpose, a confocal pinhole aperture may be arranged in a detection beam path between the beam splitter and the measuring device. However, confocal detection is not absolutely necessary for MINFLUX microscopy.

A third aspect of the present disclosure relates to a computer program comprising commands that cause the MINFLUX microscope according to the second aspect to perform the method according to the first aspect. The computer program may be implemented in the form of software or hardware components and may be stored on a volatile or non-volatile storage medium. It may be physically connected to the control unit and/or the computing unit or integrated into a unit. Alternatively, the storage medium may also be physically separate from, but in communication with, the control unit and/or the computing unit.

Further embodiments of the MINFLUX microscope according to the second aspect and of the computer program according to the third aspect result from the embodiments of the method according to the first aspect described above. Conversely, further aspects of the method according to the first aspect and of the computer program according to the third aspect result from embodiments of the MINFLUX microscope according to the second aspect.

Advantageous embodiments of the present disclosure result from the patent claims, the description and the drawings and the associated explanations of the drawings. The described advantages of features and/or combinations of features of the present disclosure are merely exemplary and may be alternative or cumulative in effect.

With regard to the disclosure content (but not the scope of protection) of the original application documents and the patent, the following applies: Further features can be seen in the drawings—in particular the relative arrangements and functional connections shown. The combination of features of different embodiments of the present disclosure or of features of different patent claims is also possible, deviating from the selected references of the patent claims, and is hereby suggested. This also applies to features that are shown in separate drawings or mentioned in their description. These features can also be combined with features of different patent claims. Similarly, features listed in the patent claims may be omitted for further embodiments of the present disclosure, but this does not apply to the independent patent claims of the granted patent.

The reference signs contained in the patent claims do not constitute a limitation of the scope of the subject matter protected by the patent claims. They serve only to make the patent claims easier to understand.

The following describes embodiments of the present disclosure with reference to the figures. These do not limit the subject matter of this disclosure and the scope of protection.

### BRIEF DESCRIPTION OF THE FIGURES

FIG. 1 shows a first embodiment of a MINFLUX microscope according to the present disclosure;

FIG. 2 shows a second embodiment of a MINFLUX microscope according to the present disclosure;

FIG. 3 shows a beam scanner for a MINFLUX microscope according to the present disclosure based on a first embodiment;

FIG. 4 shows a beam scanner for a MINFLUX microscope according to the present disclosure based on a second embodiment;

FIG. 5 shows a loop-shaped path of the intensity distribution of the illumination light according to a first embodiment;

FIG. 6 shows a loop-shaped path of the intensity distribution of the illumination light according to a second embodiment;

FIG. 7 shows a loop-shaped path of the intensity distribution of the illumination light according to a third embodiment;

FIG. 8 shows a loop-shaped path of the intensity distribution of the illumination light according to a fourth embodiment;

FIG. 9 shows a path of the intensity distribution of the illumination light in the form of a Lissajous figure according to a fifth embodiment;

FIG. 10 shows a path of the intensity distribution of the illumination light in the form of a Lissajous figure according to a sixth embodiment;

FIG. 11 shows a path of the intensity distribution of the illumination light in the form of a Lissajous figure according to a seventh embodiment;

FIG. 12 shows a path of the intensity distribution of the illumination light in the form of a Lissajous figure according to an eighth embodiment;

FIG. 13 shows a rosette-shaped path of the intensity distribution of the illumination light according to a ninth embodiment;

FIG. 14 shows a rosette-shaped path of the intensity distribution of the illumination light according to a tenth embodiment;

FIG. 15 shows a rosette-shaped path of the intensity distribution of the illumination light according to an eleventh embodiment;

FIG. 16 shows a rosette-shaped path of the intensity distribution of the illumination light according to a twelfth embodiment;

FIG. 17 shows a rosette-shaped path of intensity distribution of the illumination light according to a thirteenth embodiment;

FIG. 18 shows a rosette-shaped path of intensity distribution of the illumination light according to a fourteenth embodiment;

FIG. 19 shows a rosette-shaped path of the intensity distribution of the illumination light according to a fifteenth embodiment;

### DESCRIPTION OF THE FIGURES

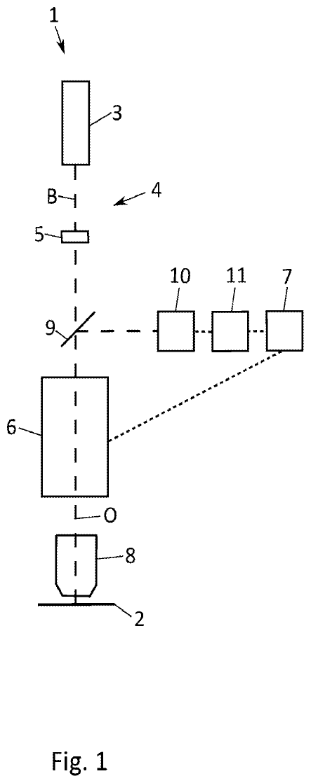

FIG. 1 shows a first embodiment of a MINFLUX microscope 1 according to the present disclosure comprising a light source 3, in particular a laser, which generates an illumination light beam B, particularly wherein the illumination light beam B is an excitation light beam which excites emitters E in a sample 2 to emit light, in particular luminescence emission, further in particular fluorescence emission.

The illumination light beam B passes through an illumination optic 4, which comprises a light modulator 5, e.g., a phase filter or a spatial light modulator with controllable pixels. In particular, the light modulator 5 modulates the phase of the illumination light beam B in such a way that an intensity distribution of the illumination light with a central intensity minimum, i.e., a minimum located on an optical axis O of the illumination light beam B, is formed at the focus in the sample 2 by interference.

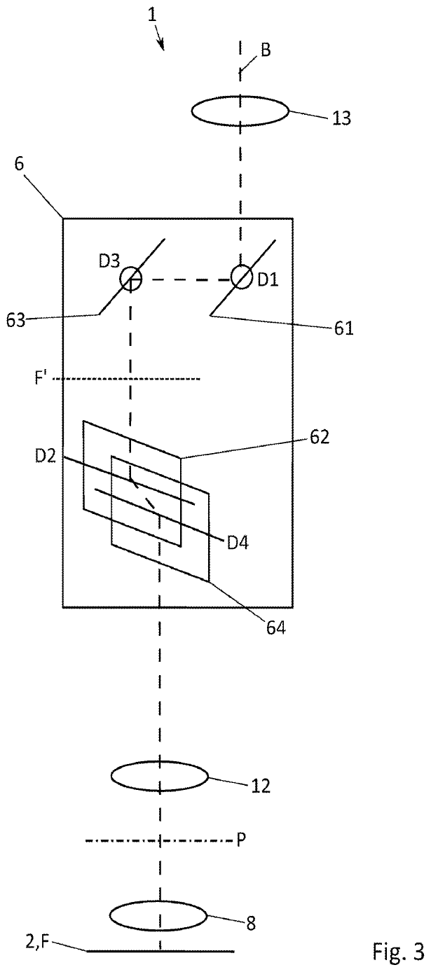

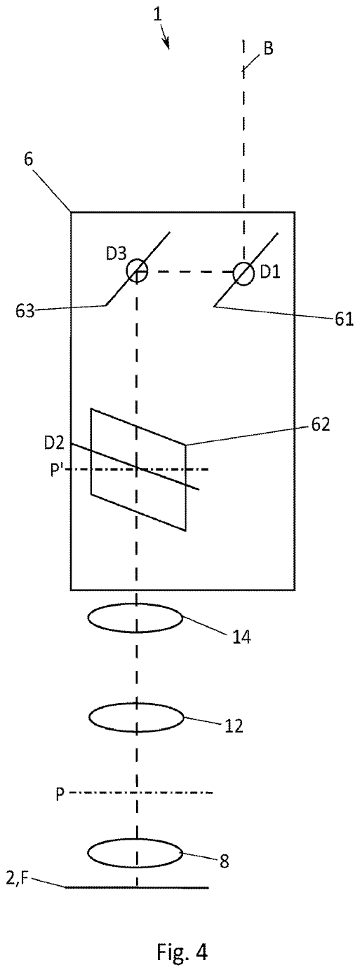

Via a beam splitter 9, which separates the illumination light from the emission light emanating from the sample 2, the illumination light beam B reaches a beam scanner 6 with at least one optical component 61, 62, 63, 64 (see FIG. 3 and FIG. 4), which displaces the illumination light beam B relative to the sample 2. In particular, the beam scanner 6 is designed as a mechanical scanner, e.g., as a galvanometer scanner.

A control unit 7 is connected to the beam scanner 6 and provides the beam scanner 6 with control signals that determine the states of the at least one optical component 61, 62, 63, 64 to displace the intensity distribution in the sample 2 to a desired position.

The illumination light beam B is then focused into the sample 2 by an objective lens 8 to form the intensity distribution of the illumination light with the central minimum.

Emitters in the sample 2 excited by the illumination light emit emission light, in particular fluorescence light, which is collected by the objective lens 8 into an emission light beam and de-scanned by the beam scanner 6. The emission light beam is then reflected at the beam splitter 9 into a detection beam path, where a measuring device 10, in particular a point detector such as an APD or a spatially resolving detector such as an APD array, is arranged.

In particular, the measuring device 10 detects and registers photons emitted by the emitter E in the sample 2 and determines a photon rate.

The measuring device 10 is coupled to a computing unit 11, which assigns the emissions, in particular the photon rate, to a scanning position 21 in the sample 2 at which the central minimum of the intensity distribution of the illumination light was positioned for a respective measurement period, and calculates an estimated position of the emitter E in the sample 2 from the emissions and the assigned scanning positions 21 using a position estimation algorithm.

According to the present disclosure, the beam scanner 6 displaces the intensity distribution along a path 20, i.e. a continuous curve in the sample 2, during a measurement cycle.

To this end, the control unit 7 provides control signals, which can be described as a function of time by a sine function or by a weighted sum of sine functions with a finite number of summands. In particular, this applies not only to the control signals but also to the nominal movements of at least one optical component 61, 62, 63, 64 of the beam scanner 6.

The parameters of the control signals are selected such that the intensity distribution is displaced along the path 20 both at scanning positions 21 in an outer region 23 of a close range 22 of the emitter E and at scanning positions 21 in an inner region 24 of the close range 22 of the emitter E, wherein the scanning positions 21 are arranged around an expected position of the emitter E in the sample 2 in at least two spatial directions x, y.

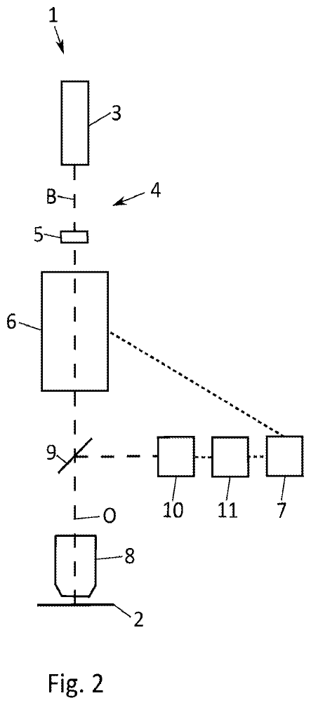

FIG. 2 shows a second embodiment of a MINFLUX microscope 1 according to the present disclosure. In this embodiment, the beam scanner 6 is arranged in the illumination beam path between the light source 3 and the beam splitter 9 so that the beam scanner 6 does not de-scan the emission light emitted from the sample 2 (so-called non-de-scanned design). Here, the beam scanner 6 may also be, for example, an electro-optical deflector that is supplied with control signals that can be described by sine functions or weighted sums of sine functions. Apart from the position of the beam scanner 6 in the beam path, the components and functions of the MINFLUX microscope are identical to the components and functions shown in FIG. 1 and described above. Identical components are marked with identical reference symbols.

FIG. 3 shows a first embodiment of a beam scanner 6 for a MINFLUX microscope 1 according to the present disclosure, a form of galvanometer scanner known as a quad scanner with four optical components 61, 62, 63, 64, which are designed respectively as rotatable mirrors coupled to a galvo drive. The optical components are rotatable around rotation axes D1, D2, D3, D4 driven by the respective galvo drive. The first axis of rotation D1 of the first optical component 61 and the third axis of rotation D3 of the third optical component 63 are parallel to each other, and the second axis of rotation 62 of the second optical component 62 and the fourth axis of rotation 64 of the fourth optical component 64 are also parallel to each other. The first optical component 61 and the third optical component 63 jointly deflect the illumination light beam B in a first spatial direction x relative to the sample 2, and the second optical component 62 and the fourth optical component 64 jointly deflect the illumination light beam B in a second spatial direction y relative to the sample 2. In the example shown in FIG. 3, the illumination light beam B is deflected sequentially by the first optical component 61, the third optical component 63, the second optical component 62, and the fourth optical component 64. However, this is only one of many possible configurations.

Between the third optical component 63 and the second optical component 62 there is an image plane F′, which is conjugate to a focal plane F in the sample 2. In other words, the objective lens 8 and a tube lens 12 form an optical relay that images the focal plane F onto the image plane F′ within the beam scanner 6. A focusing lens 13 focuses the illumination light beam B emitted by the light source 3 onto this image plane F′.

In particular, the first optical component 61 and the third optical component 63 are controlled in such a way that the illumination light beam B always hits the same point in a pupil P (back aperture) of the objective lens 8, regardless of the position of the rotatable mirrors. Different deflections then only lead to a tilt of the illumination light beam B in the pupil P, which, due to the focusing by the objective lens 8, results in a lateral deflection of the focus in the sample 2 in the first spatial direction x. In particular, the same principle also applies in particular to the deflection in the second spatial direction y.

In particular, this has the advantage for MINFLUX microscopy that the intensity distribution of the illumination light B in the sample 2 remains constant regardless of its lateral position.

If the optical components are to be controlled in such a way that the illumination light beam B hits the same point in the pupil P of the objective lens 8 for each deflection, the first optical component 61 and the third optical component 63 will in particular be controlled together with a first control signal that determines the displacement of the intensity distribution in the first spatial direction x, i.e., the first optical component 61 and the third optical component 63 are controlled with sine functions of the same frequencies and amplitudes. The same applies in particular to the second optical component 62 and the fourth optical component 64 with regard to the second spatial direction y. They are driven together with a second control signal that is sinusoidal or can be described as a weighted sum of sine functions.

In particular, if small displacements in the pupil P are tolerable, e.g., because the resulting deformations of the intensity distribution are negligibly small, or because the resulting effects on the position estimator for the various scanning positions 21, which are distributed symmetrically around a center, can be averaged out, only the first optical component 61 or only the third optical component 63 may be driven with the sinusoidal or weighted sum of sinusoidal functions to achieve the deflection of the intensity distribution in the first spatial direction x, while the other optical component 61 or 63 is kept at rest or performs a defined movement (in particular of lower frequency and/or amplitude). This applies analogously to the control of the second optical component 62 or the fourth optical component 64.

In the cases described above, when using the configuration shown in FIG. 3, it is advantageous to control only the first optical component 61 and the fourth optical component 64 using the method according to the present disclosure, since these optical components are furthest away from the image plane F′, and thus the same amplitude of movement of the intensity distribution in the sample 2 can be achieved with a smaller amplitude of rotation of the optical components around the respective axes of rotation (a smaller stroke).

FIG. 4 shows a further example of a beam scanner 6 for the MINFLUX microscope 1 according to the present disclosure, a variant of a galvanometer scanner known as a tandem scanner, pupil scanner, or x2y scanner.

The beam scanner 6 comprises a first optical component 61 rotatable around a first axis of rotation D1, a second optical component 62 rotatable around a second axis of rotation D2, and a third optical component 63 rotatable around a third axis of rotation D3, each of which is designed as a mirror coupled to a galvanometer drive.

The illumination light beam B is deflected successively by the first optical component 61, the third optical component 62, and the second optical component 62. However, other arrangements are of course also possible.

The first optical component 61 and the third optical component 63 jointly deflect the illumination light beam B in a first spatial direction x, and the second optical component deflects the illumination light beam B in a second spatial direction y.

In the beam scanner 6 shown in FIG. 4, the second optical component 62 is arranged in a pupil plane P′. This is achieved by imaging the pupil P (back aperture) of the objective lens 8 by the tube lens 12 and a scan lens 14.

According to a variant of the beam scanner 6 shown in FIG. 4, the second optical component 62, which deflects the illumination light beam B in the second spatial direction y, is a rotatable mirror of a resonant mechanical scanner, while the first optical component 61 and the third optical component are rotary mirrors coupled to galvo motors. In this case, in particular, the second optical component 62 is supplied with the control signal having the highest frequency.

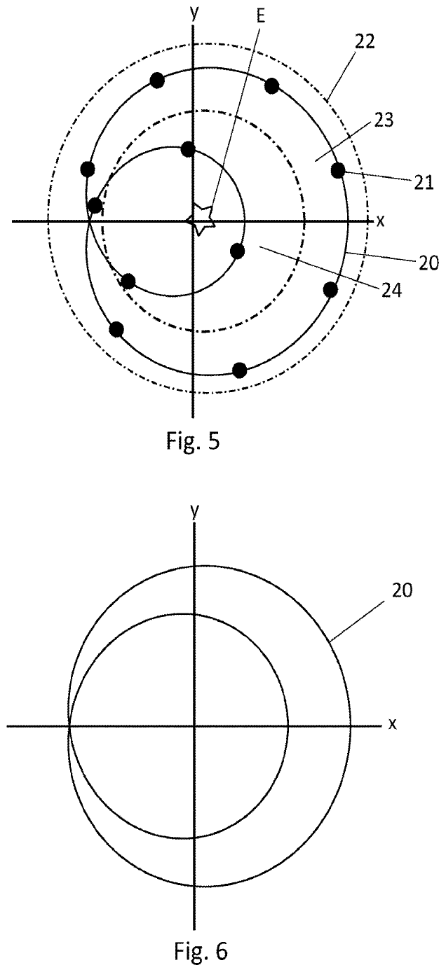

FIG. 5 schematically shows an example of the method according to the present disclosure, in which, by driving the beam scanner 6, an intensity distribution of the illumination light with a central minimum is displaced on a path 20 in the sample 2 in a close range 22 of an expected position of an emitter E.

The path 20 here is a Pascal's screw, a subform of the path 20 referred to in the present application as a loop, which can be obtained by a first control signal for one or more optical components 61, 63 that displace the intensity distribution in the x-direction of the form x=A₁ cos(ω₁t)+A₂ cos(ω₂t), and a second control signal for one or more optical components 62, 64 that displace the intensity distribution in the y-direction of the form y=A₁ sin(ω₁ t)+A₂ sin(ω₂t). In the specific example shown, the conditions ω₁=2ω₂ and A₂=2A₁ apply.

Along the path 20, scanning positions 21 are shown at regular intervals, to which emissions from the emitter E detected by the measuring device 10 in a specific measuring period are assigned to localize the emitter E. Of course, significantly more scanning positions 21 may also be provided, which are arranged closer together on the path 20.

Furthermore, FIG. 5 shows a circular inner region 24 of the close range 22 and a circular ring shaped outer region 23 of the close range 22 arranged around the inner region 24.

It can be seen from FIG. 5 that scanning positions 21 are arranged approximately on two concentric circles, so that the scanning positions 21 are located both in the outer region 23 and in the inner region 24 of the close range 22, and that the set of scanning positions 21 is arranged in the two spatial directions x,y around the expected position of the emitter E.

FIG. 6 shows a further path 20 belonging to the Pascal screw category. The path 20 can also be generated by a first control signal of the form x=A₁ cos(ω₁ t)+A₂ cos(ω₂t) and a second control signal of the form y=A₁ sin(ω₁ t)+A₂ sin(ω₂t), here with the conditions ω₁=2ω₂ and A₂=4A₁. As with the path 20 shown in FIG. 5, the scanning positions 21 (not shown in FIG. 6 for clarity) are approximately located on two concentric circles. The larger amplitude ratio results in an inner, approximately circular, partial path with a larger radius compared to the path 20 shown in FIG. 5. This comparison shows that by adjusting the amplitude ratio, specific inner regions 24 of different sizes can be scanned with the intensity distribution. In the path 20 shown in FIG. 5, the smaller approximate inner circle means that the scanning points 21 are closer to the center of the path 20, which can be advantageous, for example, for background correction in position determination if the center corresponds to the previously estimated emitter position. An even smaller amplitude ratio, e.g., A₂=1.5A₁, can be used to generate a path 20 with scanning points 21 even closer to the center (not shown).

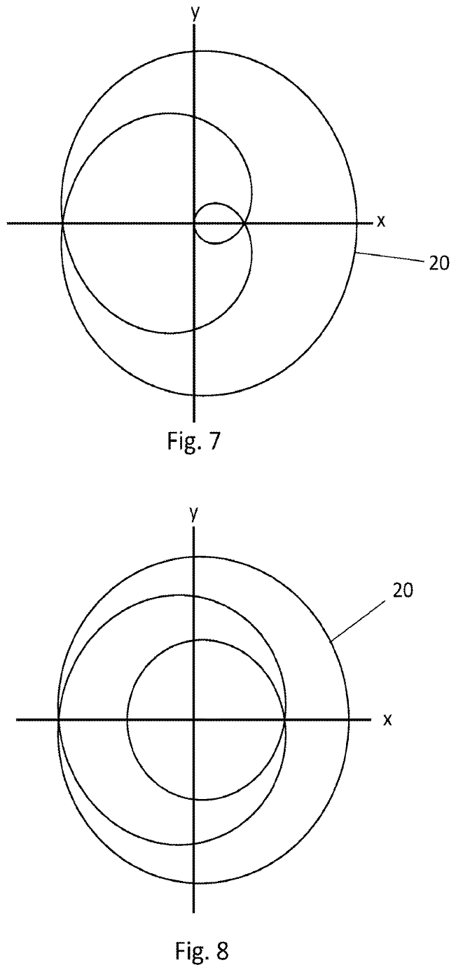

FIGS. 6 and 7 show loops that do not belong to Pascal's screws and each comprise three approximately circular sections (so-called triple loops). These can be generated by a first control signal of the form x=A₁ cos(ω₁ t)+A₂ cos(ω₂t) and a second control signal of the form y=A₁ sin(ω₁ t)+A₂ sin(ω₂t). The frequency ratio is ω₁=3/2 ω₂ in each case. In the path 20 shown in FIG. 7, all four amplitudes are equal. To generate the path 20 shown in FIG. 8, the amplitude ratio A₂/A₁ is set to 2.5 for both control signals (x and y directions). Both paths 20 consist approximately of three concentric circles, of which at least scanning positions 21 on the innermost circle lie in the inner region 24 and of which at least scanning positions 21 on the outermost circle lie in the outer region 23. The innermost of the three approximate circles is located near a center of the path 20 according to FIG. 7, which is particularly arranged at a presumed emitter position E. In particular, this has advantages for background correction in the course of position determination. For example, a central scanning position 21 can be used as a control for background correction, since the signal intensity above the background is lower the closer a scanning position 21 is to the actual emitter position.

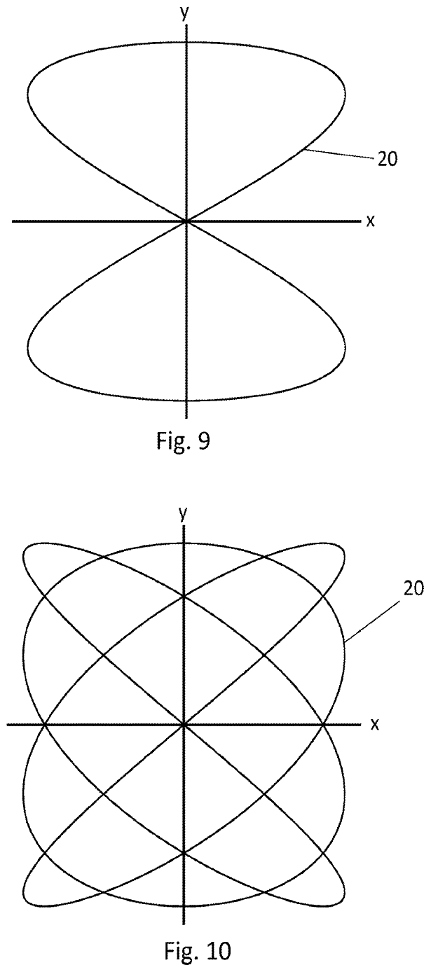

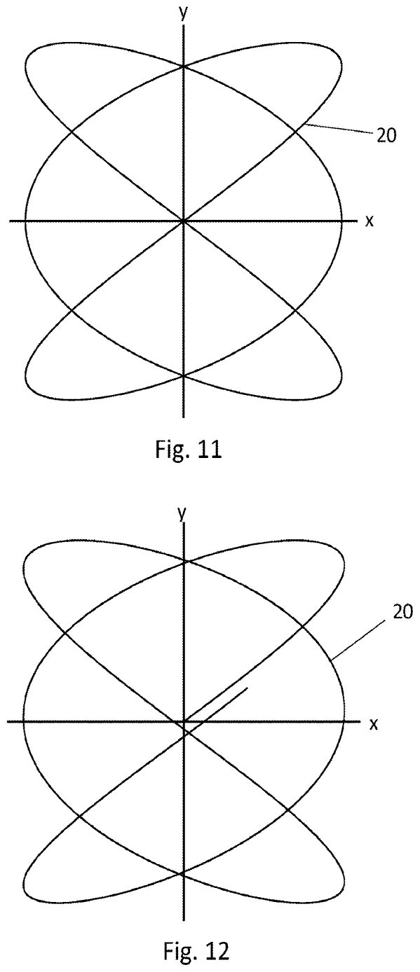

FIGS. 9, 10, 11, and 12 show further paths 20 according to the present disclosure, namely Lissajous figures. Such paths 20 can be generated by first control signals of the form x=Aₓ (sin ω₁ t) and second control signals of the form y=A_{y} (sin ω₂t). For the path 20 shown in FIG. 9, ω₁=2ω₂ and Aₓ=A_{y} apply. The parameters of the path 20 shown in FIG. 10 are ω₁=4/3ω₂ and Aₓ=A_{y}, and the parameters of the path shown in FIG. 11 are ω₁=3/2ω₂ and Aₓ=A_{y}. For the paths 20 according to FIGS. 9 to 11, the frequencies are therefore respectively in the ratio of a rational number. As a result, the corresponding Lissajous figures are closed, i.e., the same figure is always traced during multiple revolutions.

In contrast, for the path 20 shown in FIG. 12, the frequency ratio 3.02/2 was selected (ω₁=3.02/2ω₂ and Aₓ=A_{y}). This results in a non-closed path 20.

Closed paths 20, such as those shown in FIG. 5 to FIG. 11, are advantageous in many applications of the method according to the present disclosure, in particular because constant scanning positions 21 can be specified for each revolution of the path 20, which particularly reduces the computational effort involved in determining the position. In some cases, however, paths 20 that shift with each pass (e.g., the path 20 shown in FIG. 12) can also have advantages. For example, a measurement cycle with several revolutions, in which the path 20 shifts in a circumferential direction in each case, could be used to scan the sample 2 particularly densely.

The closed Lissajous paths 20 shown in FIG. 9 to FIG. 11 have the advantage that the scanning positions 21 (see FIG. 5, not shown here for clarity) are arranged both in an outer region 23 and in an inner region 2 of the close range 22 of the emitter E, with the paths 20 each having a center at the coordinate origin that is swept by the path 20. In particular, the position of the path 20 in the sample 2 can be determined that this coordinate origin lies at a pre-estimated position of the emitter E. A set of scanning positions 21 lying on the path 20 is thus arranged in two spatial directions around the center, and the scanning positions 21 can be placed symmetrically around the center, which allows position determination that is largely independent of the actual emitter position.

At the center, i.e., at the coordinate origin, there may be another scanning position 21, which can be used either for position determination or for determining a control value for background correction.

FIGS. 12 to 17 show further paths 20 according to the present disclosure, namely so-called rosettes or cloverleaf curves.

Such paths 20 can be generated by first control signals of the form

$$x = {A}_{1}^{x} cos ( {ω}_{1}^{x} t + {φ}_{1}^{x} ) + {A}_{2}^{x} cos ( {ω}_{2}^{x} t + {φ}_{2}^{x} )$$

and second control signals of the form

$$y = {A}_{1}^{y} sin ( {ω}_{1}^{y} t + {φ}_{1}^{y} ) - {A}_{2}^{y} sin ( {ω}_{2}^{y} t + {φ}_{2}^{y} ) .$$

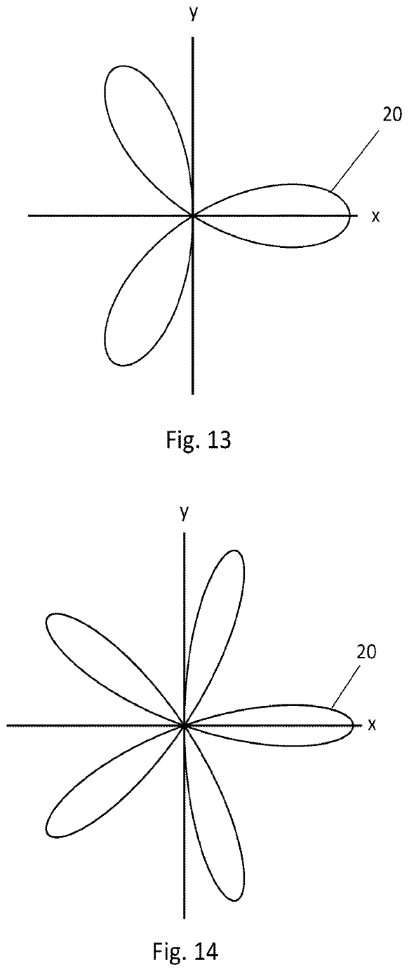

In the path 20 according to FIG. 13, the frequency ratios

$${ω}_{1}^{x} / {ω}_{2}^{x} and {ω}_{1}^{y} / {ω}_{2}^{y}$$

are each 2/1, and in the path 20 according to FIG. 14, the frequency ratios are each 3/2. All four amplitudes are identical in these paths 20. The rosette according to FIG. 13 has three leaves, while the rosette according to FIG. 14 comprises five leaves. With a higher number of leaves, a denser and more homogeneous distribution of the scanning positions 21 (see FIG. 5) in the sample 2 can be achieved overall. The paths 20 each pass through a center at the coordinate origin, which has the advantages explained above in the context of the Lissajous figures.

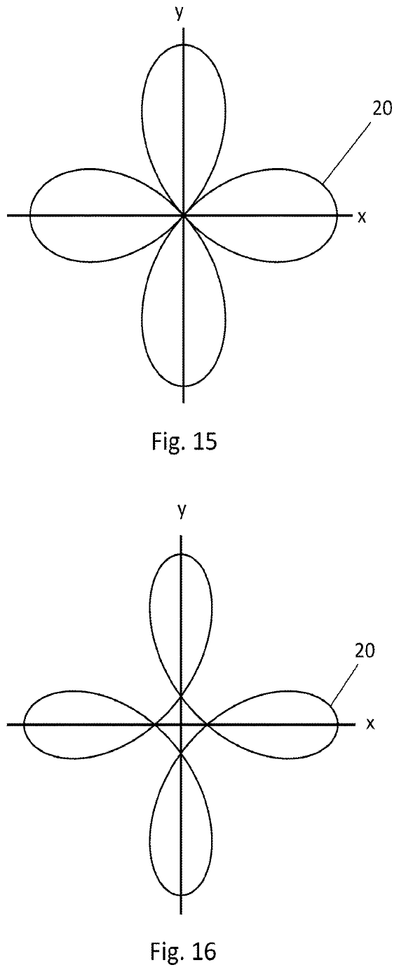

FIGS. 15 and 16 show rosettes with four leaves, which can be generated by frequency ratios

$${ω}_{1}^{x} / {ω}_{2}^{x} and {ω}_{1}^{y} / {ω}_{2}^{y}$$

of 3/1 in each case. In the path 20 shown in FIG. 15, all four amplitudes are identical, while the path shown in FIG. 16 is produced by the parameters

$${A}_{2}^{x} = 0 , 8 {A}_{1}^{x} and {A}_{2}^{y} = 0 , 8 {A}_{1}^{y} ,$$

i.e., by different amplitudes of the summands within a control signal. As a result, the rosette-shaped path shown in FIG. 16 no longer passes through the center at the origin of the coordinates, but orbits around it, so that scanning positions 21 can be arranged symmetrically around the center on two concentric circles.

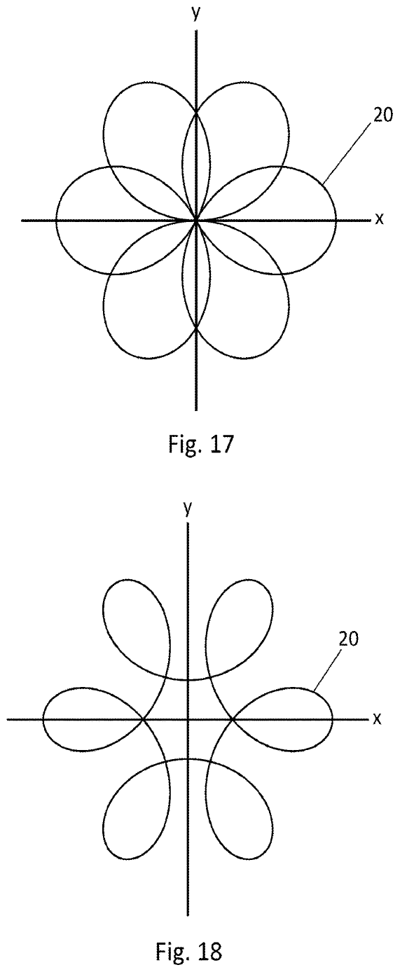

As can be seen from FIGS. 17 and 18, a similar effect results for a six-leave rosette which can be generated by control signals with frequency ratios

$${ω}_{1}^{x} / {ω}_{2}^{x} and {ω}_{1}^{y} / {ω}_{2}^{y}$$

of 5/1 respectively, wherein four identical amplitudes were selected for FIG. 17, and the equations

$${A}_{2}^{x} = 0 , 6 {A}_{1}^{x} and {A}_{2}^{y} = 0 , 6 {A}_{1}^{y}$$

apply to the path 20 according to FIG. 18.

The path 20 shown in FIG. 18 is particularly advantageous because scanning positions 21 can be defined on the path 20 that form two hexagons of different sizes concentric around the coordinate origin. This allows two hexagonal patterns of scanning position 21 of different sizes to be realized, as used in the prior art (by stepwise scanning with electro-optical deflectors), within a single path 20. This allows, for example, iterative MINFLUX methods known from the prior art, in which the radius of the scanning pattern is reduced in two successive iterations, to be implemented in a single continuous path 20. These scanning positions 21 then have a high degree of rotational symmetry and closely approximate two concentric circles.

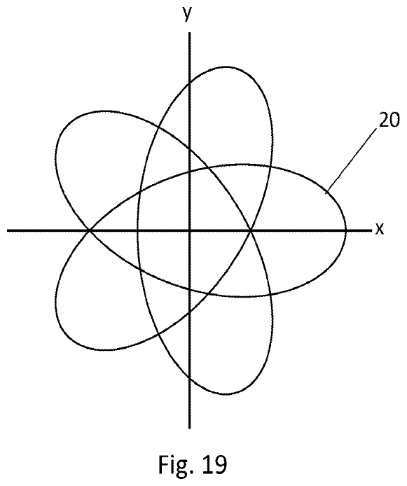

Finally, FIG. 19 shows a rosette-shaped path 20 that can be generated by control signals with frequency ratios

$${ω}_{1}^{x} / {ω}_{2}^{x} and {ω}_{1}^{y} / {ω}_{2}^{y}$$

of 3/2 in each case, wherein the amplitudes

$${A}_{1}^{x} and {A}_{1}^{y}$$

as well as

$${A}_{2}^{x} and {A}_{2}^{y}$$

are equal and the amplitudes

$${A}_{1}^{x} and {A}_{2}^{x}$$

as well as

$${A}_{1}^{y} and {A}_{2}^{y}$$

are each in a ratio of 2/1. This results in a rosette with five leaves, in which the center is orbited at the coordinate origin and, similar to the path 20 shown in FIG. 18, scanning positions 21 can be arranged on circles with multiple radii rotationally symmetrical around the center, so that, in particular, several steps of an iterative MINFLUX process can be realized with one path 20.

### LIST OF REFERENCE SYMBOLS

1 MINFLUX microscope
2 Sample
3 Light source
4 Illumination optic
5 Light modulator
6 Beam scanner
7 Control unit
8 Objective lens
9 Beam splitter
10 Measuring device
11 Computing unit
12 Tube lens
13 Focusing lens
14 Scan lens
15 Path
21 Scanning position
22 Close range
23 Outer region
24 Inner region
61 First optical component
62 Second optical component
63 Third optical component
64 Fourth optical component
B Illumination light beam
D1 First axis of rotation
D2 Second axis of rotation
D3 Third axis of rotation
D4 Fourth axis of rotation
E Emitter
F Focal plane
F′ Image plane
O Optical axis
P Pupil
P′ Pupil plane

1.-16. (canceled)

17. A method for localizing or tracking an emitter in a sample using a MINFLUX method, wherein the MINFLUX method is a localization or tracking method for individual emitters in which a light distribution of illumination light that excites light emissions from the emitter is generated at the focus in the sample, wherein the light distribution comprises a local minimum and in which the position of an individual emitter is determined by detecting light emissions from the emitter for different positions of the minimum or for different light distributions in a close range of the emitter,
wherein the sample is illuminated in the close range of the emitter by an illumination light beam having an intensity distribution of illumination light that comprises a central minimum, wherein the illumination light is excitation light, and wherein the illumination light excites the emitter to emit light,
wherein the intensity distribution is displaced during a measurement cycle by a beam scanner comprising at least one optical component displacing the illumination light beam to scanning positions,
and wherein emissions from the emitter are detected for the scanning positions and assigned to the scanning positions,
wherein the beam scanner is controlled by control signals to displace the intensity distribution along a continuous path during the measurement cycle, wherein the intensity distribution is displaced along the path both to scanning positions in an outer region of the close range of the emitter and to scanning positions in an inner region of the close range of the emitter, wherein the scanning positions are arranged around an expected position of the emitter in the sample in at least two spatial directions, and wherein the control signals and/or nominal movements of the at least one optical component can be described respectively as a function of time by a sine function or by a weighted sum of sine functions with a finite number of summands,
wherein the sine function has a time-constant frequency and a time-constant amplitude over the measurement cycle or the sine functions of the sum have respective time-constant frequencies and respective time-constant amplitudes over the measurement cycle,
and wherein a position of the emitter is estimated from a plurality of emissions from the emitter and a plurality of scanning positions assigned to the emissions.

18. The method according to claim 17, wherein the control signals can be described respectively as a function of time by a sine function or a weighted sum of ten sine functions or less.

19. The method according to claim 17, wherein the beam scanner is controlled by a first control signal and a second control signal, wherein the first control signal causes a displacement of the intensity distribution along a first spatial direction, and wherein the second control signal causes a displacement of the intensity distribution along a second spatial direction, wherein the first control signal and the second control signal can each be described as a function of time by a sine function or by a weighted sum of sine functions with a finite number of summands.

20. The method according to claim 19, wherein the first control signal can be described by the function x=Aₓ sin(ω₁t+φ₁), wherein the second control signal can be described by the function y=A_{y} sin(ω₂t+φ₂) wherein Aₓ denotes an amplitude of the first control signal, wherein A_{y} denotes an amplitude of the second control signal, wherein t denotes time, wherein ω₁ denotes a frequency of the first control signal, wherein ω₂ denotes a frequency of the second control signal, wherein φ₁ denotes a phase of the first control signal, and wherein φ₂ denotes a second phase of the second control signal, wherein the frequency of the first control signal is unequal to the frequency of the second control signal.

21. The method according to claim 20, wherein a ratio between the frequency of the first control signal and the frequency of the second control signal, or a ratio between the first frequency and the second frequency of the first control signal and a ratio between the first frequency and the second frequency of the second control signal is a rational number unequal to 1.

22. The method according to claim 20, wherein the path of the intensity distribution is a Lissajous curve.

23. The method according to claim 19, wherein the first control signal can be described by the function
$$x = {A}_{1}^{x} sin ( {ω}_{1}^{x} t + {φ}_{1}^{x} ) ∓ {A}_{2}^{x} sin ( {ω}_{2}^{x} t + {φ}_{2}^{x} ) ,$$
wherein the second control signal can be described by the function
$$y = {A}_{1}^{y} sin ( {ω}_{1}^{y} t + {φ}_{1}^{y} ) ∓ {A}_{2}^{y} sin ( {ω}_{2}^{y} t + {φ}_{2}^{y} ) ,$$
wherein
$${A}_{1}^{x}$$
denotes a first amplitude of the first control signal, wherein
$${A}_{2}^{x}$$
denotes a second amplitude of the first control signal, wherein
$${A}_{1}^{y}$$
denotes a first amplitude of the second control signal, wherein
$${A}_{2}^{y}$$
denotes a second amplitude of the second control signal, wherein t denotes time, wherein
$${ω}_{1}^{x}$$
denotes a first frequency of the first control signal, wherein
$${ω}_{2}^{x}$$
denotes a second frequency of the first control signal, wherein
$${ω}_{1}^{y}$$
denotes a first frequency of the second control signal, wherein
$${ω}_{2}^{y}$$
denotes a second frequency of the second control signal, wherein
$${φ}_{1}^{x}$$
denotes a first phase of the first control signal, wherein
$${φ}_{2}^{x}$$
denotes a second phase of the first control signal, wherein
$${φ}_{1}^{y}$$
denotes a first phase of the second control signal, and wherein
$${φ}_{2}^{y}$$
denotes a second phase of the second control signal.

24. The method according to claim 23, wherein a ratio between the frequency of the first control signal and the frequency of the second control signal, or a ratio between the first frequency and the second frequency of the first control signal and a ratio between the first frequency and the second frequency of the second control signal is a rational number unequal to 1.

25. The method according to claim 23, wherein the path of the intensity distribution is an epitrochoid or a hypertrochoid.

26. The method according to claim 17, wherein the intensity distribution is displaced by rotational movements of the at least one optical component of the beam scanner around at least one axis of rotation.

27. The method according to claim 26, wherein the beam scanner comprises a first optical component that is rotatable around a first axis of rotation and a second optical component that is rotatable around a second axis of rotation, wherein the intensity distribution is displaced in a first spatial direction by a first rotational movement of the first optical component around the first axis of rotation, and wherein the intensity distribution is displaced in a second spatial direction by a second rotational movement of the second optical component around the second axis of rotation, so that the intensity distribution is displaced on the path by superimposing the first rotational movement and the second rotational movement, wherein first control signals of the first optical component and second control signals of the second optical component can be described respectively by sine functions or weighted sums of sine functions with a finite number of summands.

28. The method according to claim 26, wherein the beam scanner comprises an optical component that is rotatable around a first axis of rotation and around a second axis of rotation, wherein the intensity distribution is displaced in a first spatial direction by a first rotational movement of the optical component around the first axis of rotation and is displaced in a second spatial direction by a second rotational movement of the optical component around the second axis of rotation, so that the intensity distribution is displaced on the path by superimposing the first rotational movement and the second rotational movement, wherein first control signals controlling the first rotational movement around the first axis of rotation and second control signals controlling the second rotational movement around the second axis of rotation can be described respectively by sine functions or weighted sums of sine functions with a finite number of summands.

29. The method according to claim 17, wherein the beam scanner comprises at least two optical components which are configured to displace the intensity distribution in the same spatial direction in the sample, wherein only one of the at least two optical components is controlled by the control signals to displace the intensity distribution along the path in the measurement cycle.

30. The method according to claim 17, wherein the path is point- or rotationally symmetrical with respect to an expected position of the emitter or axially symmetrical with respect to a straight line on which an expected position of the emitter lies, or at least a subset of the scanning positions is arranged at least approximately rotationally symmetrical around an expected position of the emitter.

31. The method according to claim 17, wherein after the measurement cycle, a further measurement cycle is performed, wherein the path for the further measurement cycle is shifted and/or scaled relative to the sample based on an emitter position estimated in the preceding measurement cycle, wherein the control signals for the further measurement cycle are adjusted based on the emitter position estimated in the preceding measurement cycle.

32. The method according to claim 31, wherein the shift of the path relative to the sample and/or a scaling of the path is performed at a predetermined point of the path, wherein the predetermined point is selected such that a minimum acceleration and/or a minimum jerk of the at least one optical component results and/or such that a relaxation process of the at least one optical component is optimized.

33. The method according to claim 17, wherein the path of the intensity distribution extends in a focal plane that is perpendicular to an optical axis of an objective lens focusing the illumination light beam into the sample.

34. The method according to claim 17, wherein the path of the intensity distribution is closed.

35. A MINFLUX microscope for localizing or tracking an emitter in a sample according to a MINFLUX method, wherein the MINFLUX method is a localization or tracking method for individual emitters in which a light distribution of illumination light that excites light emissions from the emitter is generated at the focus in the sample, wherein the light distribution comprises a local minimum and in which the position of an individual emitter is determined by detecting light emissions from the emitter for different positions of the minimum or for different light distributions in a close range of the emitter, wherein the MINFLUX microscope comprises
a light source configured to generate an illumination light beam,
an illumination optic configured to illuminate a sample in a close range of an emitter by an intensity distribution of illumination light that comprises a central minimum, wherein the illumination light is excitation light or emission inhibition light, in particular STED light, and wherein the illumination light or another light excites the emitter to emit light,
a beam scanner comprising at least one optical component that displaces the illumination light beam, wherein the beam scanner is configured to displace the intensity distribution to scanning positions during a measurement cycle, and
a measuring device configured to detect emissions from the emitter for the scanning positions,
a control unit which is configured to control the beam scanner with control signals to displace the intensity distribution along a continuous path during the measurement cycle, so that the intensity distribution is displaced along the path both to scanning positions in an outer region of the close range of the emitter and to scanning positions in an inner region of the close range of the emitter, wherein the scanning positions are arranged around an expected position of the emitter in the sample in at least two spatial directions, and wherein the control signals and/or nominal movements of the at least one optical component can be described respectively as a function of time by a sine function or by a weighted sum of sine functions with a finite number of summands, wherein the sine function has or the sine functions of the sum have a time-constant frequency and a time-constant amplitude over the measurement cycle, and
a computing unit configured to estimate a position of the emitter from a plurality of emissions from the emitter detected by the measuring device and a plurality of scanning positions assigned to the emissions.

36. A non-transitory computer-readable medium for storing computer instructions for localizing or tracking an emitter in a sample that, when executed by one or more processors associated with a MINFLUX microscope causes the one or more processors to perform a method according to claim 17.
